(19) United States
(12) Patent Application Publication
(10) Pub. No.: US 2026/0051947 A1
(43) Pub. Date: Feb. 19, 2026

(54) Electronic Device and Case with Satellite Communication Capabilities

(71) Applicant: Apple Inc., Cupertino, CA (US)

(72) Inventor: Larbi Azzoug, Santa Clara, CA (US)

(21) Appl. No.: 18/803,169

(22) Filed: Aug. 13, 2024

(51) Int. Cl. H04B 7/185; H01Q 3/22; H04B 5/43; H04B 5/79

(52) U.S. Cl. CPC H04B 7/18513; H01Q 3/22; H04B 5/43; H04B 5/79

(57) ABSTRACT

An electronic device may be mounted to a main body of a removable case. The case includes a cover that rotates between open and closed positions. The device may convey wireless data and/or a control signal with the removable case over radio-frequency connectors, near-field communications (NFC) coils, connector electrodes, and/or wired data connectors. The removable case may relay the wireless data between the electronic device and a communications satellite in space. The case may include a phased antenna array in the cover. In the open position, the cover may point the phased antenna array towards the sky. The removable case may include beamforming circuitry in the cover and coupled to the phased antenna array. The control signal may control the beamforming circuitry to produce, using the phased antenna array, a signal beam oriented towards the communications satellite.

### FIELD

This relates generally to wireless communications, including wireless communications via one or more satellites.

### BACKGROUND

Communications systems are used to convey data between user equipment devices. Some communications systems include satellites that wirelessly convey data between user equipment devices and gateways. Given the long propagation distances between user equipment devices and satellites in space, it can be difficult to ensure that user equipment devices exhibit sufficient levels of wireless performance when communicating with other devices via satellites.

### SUMMARY

A communications system may include an electronic device that is received by a removable case. The removable case may include a main body portion and a cover that rotates between open and closed positions relative to the main body portion. The main body portion may receive the electronic device (e.g., the electronic device may be mounted to the main body portion). The electronic device may convey wireless data with the removable case over a radio-frequency connector, a near-field communications (NFC) coil, a connector electrode, or a wired data connector. The removable case may relay the wireless data between the electronic device and a communications satellite in space.

The removable case may include a phased antenna array in the cover. In the open position, the cover may point the phased antenna array towards the sky. The removable case may include beamforming circuitry in the cover and coupled to the phased antenna array. The beamforming circuitry may receive the wireless data and/or a control signal from the electronic device over an additional radio-frequency connector, an additional NFC coil, an additional connector electrode, or an additional wired data connector on the removable case. The control signal may control the beamforming circuitry to produce, using the phased antenna array, a signal beam oriented towards the communications satellite. While the cover is in the open position, the phased antenna array may convey the wireless data with the satellite over the signal beam without being blocked by a user's hand while the user holds the device and the removable case.

### BRIEF DESCRIPTION OF THE DRAWINGS

FIG. 1 is a diagram of an illustrative communications system including user equipment devices that communicate via a constellation of communications satellites in accordance with some embodiments.

FIG. 2 is a schematic diagram of illustrative circuitry in a user equipment device and a removable case in accordance with some embodiments.

FIG. 3 is a circuit diagram of an illustrative radio-frequency path distributed between a user equipment device and a removable case in accordance with some embodiments.

FIG. 4 is a perspective view showing how an illustrative user equipment device may be mounted to a removable case in accordance with some embodiments.

FIG. 5 is an exterior rear view of an illustrative user equipment device having connectors for performing radio-frequency communications using a removable case in accordance with some embodiments.

FIG. 6 is an exterior front view of an illustrative removable case having connectors that are used to perform radio-frequency communications for an electronic device in accordance with some embodiments.

FIG. 7 is an interior rear view of an illustrative removable case having a movable cover that includes radio-frequency circuitry used to perform radio-frequency communications for an electronic device in accordance with some embodiments.

FIG. 8 is a side view of an illustrative user equipment device mounted to a removable case having a movable cover in a closed configuration in accordance with some embodiments.

FIG. 9 is a side view of an illustrative user equipment device mounted to a removable case having a movable cover in an open configuration in accordance with some embodiments.

FIG. 10 is a side view of an illustrative removable case having a movable cover with multiple axes of rotation in accordance with some embodiments.

FIG. 11 is a flow chart of illustrative operations involved in performing wireless communications using a user equipment device and a removable case in accordance with some embodiments.

### DETAILED DESCRIPTION

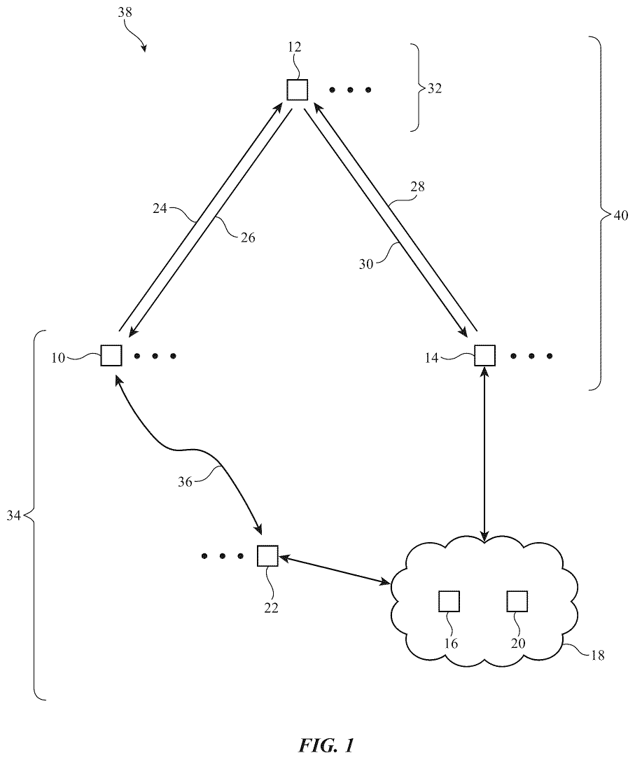

FIG. 1 is a diagram of an illustrative communications system 38. Communications system 38 (sometimes referred to herein as communications network 38, network 38, system 38, satellite communications system 38, or satellite communications network 38) may include a ground-based (terrestrial) gateway system that includes one or more gateways 14 and may include one or more user equipment (UE) devices such as devices 10. Gateways 14 and devices 10 may form a part of a terrestrial network 34 on Earth. Terrestrial network 34 may include terrestrial-based wireless communications equipment 22 and network portion 18. Terrestrial-based wireless communications equipment 22 may include, for example, one or more wireless base stations (e.g., for implementing a cellular telephone network), wireless access points (e.g., for implementing a wireless local area network (WLAN)), and/or other UE devices (e.g., for implementing a device-to-device (D2D) network, a wireless personal area network (WPAN), etc.).

Communications system 38 may include a constellation 32 of one or more communications satellites 12 (sometimes referred to herein simply as satellites 12). Devices 10, gateways 14, and constellation 32 may form a part of non-terrestrial network (NTN) 40, which conveys signals between devices 10 and gateways 14 via constellation 32. Constellation 32 may sometimes be referred to herein as satellite constellation 32. Communications satellites 12 are located in space (e.g., in orbit around Earth). Communications system 38 may include any desired number of gateways 14, any desired number of communications satellites 12, and any desired number of devices 10. Only a single gateway 14, a single communications satellite 12, and a single device 10 are illustrated in FIG. 1 for the sake of clarity. Each gateway 14 in communications system 38 may be located at a different respective geographic location on Earth (e.g., across different regions, cities, counties, prefectures, districts, municipalities, land masses, areas, localities, states, provinces, countries, continents, etc.).

Network portion 18 may be communicably coupled to terrestrial-based wireless communications equipment 22 and each of the gateways 14 in communications system 38. Gateway (GW) 14 may include a satellite network ground station and may therefore sometimes also be referred to as ground station (GS) 14 or satellite network ground station 14. Each gateway 14 may include one or more antennas (e.g., electronically and/or mechanically adjustable antennas), modems, transceivers, amplifiers, beam forming circuitry, control circuitry (e.g., one or more processors, storage circuitry, etc.) and other components that are used to convey communications data. The components of each gateway 14 may, for example, be disposed at a respective geographic location (e.g., within the same computer, server, data center, building, etc.). Gateways 14 may convey communications data between terrestrial network 34 and devices 10 via satellite constellation 32.

Network portion 18 may include any desired number of network nodes, terminals, and/or end hosts that are communicably coupled together using communications paths that include wired and/or wireless links. The wired links may include cables (e.g., ethernet cables, optical fibers or other optical cables that convey signals using light, telephone cables, etc.). Network portion 18 may include one or more relay networks, mesh networks, local area networks (LANs), wireless local area networks (WLANs), ring networks (e.g., optical rings), cloud networks, virtual/logical networks, the Internet, combinations of these, and/or any other desired network nodes coupled together using any desired network topologies (e.g., on Earth). The network nodes, terminals, and/or end hosts may include network switches, network routers, optical add-drop multiplexers, other multiplexers, repeaters, modems, servers, network cards, wireless access points, wireless base stations, UE devices such as devices 10, and/or any other desired network components. The network nodes in network portion 18 may include physical components such as electronic devices, servers, computers, user equipment, etc., and/or may include virtual components that are logically defined in software and that are distributed across (over) two or more underlying physical devices (e.g., in a cloud network configuration).

Network portion 18 may include one or more satellite network operations centers such as network operations center (NOC) 16. NOC 16 may control the operation of gateways 14 in communicating with satellite constellation 32. NOC 16 may also control the operation of the satellites in satellite constellation 32. For example, NOC 16 may convey control commands via gateways 14 that control positioning operations (e.g., orbit adjustments), sensing operations (e.g., thermal information gathered using one or more thermal sensors), and/or any other desired operations performed in space by satellites 12. NOC 16, gateways 14, and satellite constellation 32 may be operated or managed by a corresponding satellite constellation operator.

Communications system 38 may also include a satellite communications (satcom) network service provider (e.g., a satcom network carrier or operator) for controlling wireless communications between devices 10 and terrestrial network 34 via satellite constellation 32. The satcom network service provider may be a different entity than the satellite constellation operator that controls/operates NOC 16, gateways 14, and satellite constellation 32, or may be the same entity as the satellite constellation operator. Terrestrial-based wireless communications equipment 22 in terrestrial network 34 may be operated by one or more terrestrial network carriers or service providers. The terrestrial network carriers or service providers may be different entities than the satcom network service provider or, if desired, may be the same entity as the satcom network service provider.

One or more gateways 14 may control the operations of satellite constellation 32 over corresponding radio-frequency communications links. Satellite constellation 32 may include any desired number of communications satellites 12 (e.g., two satellites, four satellites, ten satellites, dozens of satellites, hundreds of satellites, thousands of satellites, etc.), three of which are shown in FIG. 1. If desired, two or more of the communications satellites 12 in satellite constellation 32 may convey radio-frequency signals between each other using satellite-to-satellite (e.g., relay) links.

The satellites 12 in constellation 32 may include a set of non-geostationary orbit (NGSO) satellites (e.g., satellites in non-geostationary orbits) and, if desired, may include a set of geostationary orbit (GSO) satellites (e.g., satellites in geostationary/geosynchronous orbits, sometimes referred to as geosynchronous satellites or GEO satellites). NGSO satellites in constellation 32 are in NGSO orbits and move at non-zero velocities relative to the surface of Earth over time. GSO satellites in constellation 32 are in GSO orbits and do not move relative to the surface of Earth (e.g., GSO satellites may orbit around Earth at a velocity that matches the rotation of Earth given the altitude of the satellites).

GSO satellites may orbit Earth at orbital altitudes of greater than around 30,000 km. Satellites 12 may include low earth orbit (LEO) satellites at orbital altitudes of less than around 8,000 km (e.g., satellites in low earth orbits, inclined low earth orbits, low earth circular orbits, etc.), medium earth orbit (MEO) satellites at orbital altitudes between around 8,000 km and 30,000 km (e.g., satellite in medium earth orbits), sun synchronous satellites (e.g., satellites in sun synchronous orbits), satellites in tundra orbits, satellites in Molniya orbits, satellites in polar orbits, and/or satellites in any other desired non-geosynchronous orbits around Earth. If desired, satellites 12 may include multiple sets of satellites each in a different type of orbit and/or each at a different orbital altitude. In general, constellation 32 may include satellites in any desired combination of orbits or orbit types. GSO satellites may be omitted from constellation 32 if desired.

The satellites in constellation 32 may communicate with one or more devices 10 on Earth using one or more radio-frequency communications links (e.g., satellite-to-user equipment links). Satellites 12 may also communicate with gateways 14 on Earth using radio-frequency communications links (e.g., satellite-to-gateway links). Radio-frequency signals may be conveyed between devices 10 and satellites 12 and between satellites 12 and gateways 14 in IEEE bands such as the IEEE C band (4-8 GHZ), S band (2-4 GHZ), L band (1-2 GHZ), X band (8-12 GHz), W band (75-110 GHz), V band (40-75 GHZ), K band (18-27 GHZ), Kₐ band (26.5-40 GHZ), Kᵤ band (12-18 GHz), and/or any other desired satellite communications bands. If desired, different bands may be used for the satellite-to-user equipment links than for the satellite-to-gateway links.

Communications may be performed between gateways 14 and devices 10 in a forward (FWD) link direction and/or in a reverse (REV or RWD) link direction. In the forward link direction (sometimes referred to simply as the forward link), wireless data is conveyed from gateways 14 to device(s) 10 via satellite constellation 32. Wireless data conveyed over the forward link is sometimes referred to herein as forward link data. Forward link data may be organized into a set, series, or stream of forward link datagrams (e.g., having header fields that contain header information, payload fields that contain a forward link data payload, etc.). A gateway 14 may, for example, transmit forward link data to one of the satellites 12 in satellite constellation 32 (e.g., where forward link datagrams are modulated onto one or more carriers of radio-frequency signals 28). Satellite 12 may transmit (e.g., relay, in a bent-pipe configuration) the forward link data received from gateway 14 to device(s) 10 (e.g., using radio-frequency signals 26). Radio-frequency signals 28 are conveyed in an uplink direction from gateway 14 to satellite 12 and are therefore sometimes also referred to herein as uplink (UL) signals 28, forward link UL signals 28, or forward link signals 28. Radio-frequency signals 26 are conveyed in a downlink direction from satellite 12 to device(s) 10 and are therefore sometimes also referred to herein as downlink (DL) signals 26, forward link DL signals 26, or forward link signals 26.

In the reverse link direction (sometimes referred to simply as the reverse link), wireless data is conveyed from device(s) 10 to gateways 14 via satellite constellation 32. Wireless data conveyed over the reverse link is sometimes referred to herein as reverse link data. Reverse link data may be organized into a set, series, or stream of reverse link datagrams (e.g., having header fields that contain header information, payload fields that contain a reverse link data payload, etc.). One of devices 10 may, for example, transmit reverse link data to one of the satellites 12 in constellation 32 (e.g., where reverse link datagrams are modulated onto one or more carriers of radio-frequency signals 24). Satellite 12 may transmit (e.g., relay, in a bent-pipe configuration) the reverse link data received from device 10 to a corresponding gateway 14 using radio-frequency signals 30. Radio-frequency signals 24 are conveyed in an uplink direction from device 10 to satellite 12 and are therefore sometimes also referred to herein as uplink (UL) signals 24, reverse link UL signals 24, or reverse link signals 24. Radio-frequency signals 30 are conveyed in a downlink direction from satellite 12 to gateway 14 and are therefore sometimes also referred to herein as downlink (DL) signals 30, reverse link DL signals 30, or reverse link signals 30. Gateway 14 may forward wireless data between device(s) 10 and network portion 18. Network portion 18 may forward the wireless data to any desired network nodes or terminals of terrestrial network 34.

If desired, devices 10 may also convey radio-frequency signals with terrestrial-based wireless communications equipment 22 over terrestrial network wireless communication links 36 when available. Terrestrial network wireless communications links 36 may be, for example, cellular telephone links (e.g., links maintained using a cellular telephone communications protocol such as a 4G Long Term Evolution (LTE) protocol, a 3G protocol, a 3GPP Fifth Generation (5G) New Radio (NR) protocol, a 6G protocol, etc.), wireless local area network links (e.g., Wi-Fi® links), wireless personal area network links (e.g., Bluetooth links), D2D links, etc.

Devices 10 are sometimes referred to herein as being “online” or “on-grid” when the devices are within range of terrestrial-based wireless communications equipment 22 and when terrestrial-based wireless communications equipment 22 provides access (e.g., communications resources) to network portion 18 for the devices. When the devices are online, the devices may communicate with other network nodes or terminals in network portion 18 via terrestrial network wireless communications links 36. Conversely, devices 10 are sometimes referred to herein as being “offline” or “off-grid” when the devices are out of range of terrestrial-based wireless communications equipment 22 or when terrestrial-based wireless communications equipment 22 does not provide access to network portion 18 for the devices (e.g., when terrestrial-based wireless communications equipment 22 is disabled due to a power outage, natural disaster, traffic surge, or emergency, when terrestrial-based wireless communications equipment 22 denies access to network portion 18 for the devices, when terrestrial-based wireless communications equipment 22 is overloaded with traffic, etc.). If desired, devices 10 may include separate antennas for handling communications over the satellite-to-user equipment link and one or more terrestrial network wireless communication links 36 or devices 10 may include a single antenna that handles both the satellite-to-user equipment link and the terrestrial network wireless communications links.

The wireless data conveyed in DL signals 26 is sometimes also referred to herein as DL data, forward link DL data, or forward link data. UL signals 28 may also convey the forward link data (e.g., forward link data that is routed by satellite 12 to device(s) 10 in DL signals 26). The wireless data conveyed in UL signals 24 is sometimes also referred to herein as UL data, reverse link UL data, or reverse link data. The reverse link data may be generated and transmitted by device(s) 10. DL signals 30 may also convey the reverse link data. Forward link data may be generated by any desired network nodes or terminals of terrestrial network 34. Forward link data and the reverse link data may include text data such as email messages, text messages, web browser data, an emergency or SOS message, a location message identifying the location of device(s) 10, or other text-based data, audio data such as voice data (e.g., for a bi-directional satellite voice call) or other audio data (e.g., streaming satellite radio data), video data (e.g., for a bi-directional satellite video call or to stream video data transmitted by gateway 14 at device(s) 10), cloud network synchronization data, data generated or used by software applications running on device(s) 10 (e.g., application data), data for use in a distributed processing network, and/or any other desired data. Devices 10 may only receive forward link data, may only transmit reverse link data, or may both transmit reverse link data and receive forward link data. Each satellite 12 may communicate with the devices 10 located within its coverage area at any given time (e.g., devices 10 located within cells on Earth that overlap the signal beam(s) producible by the satellite).

The satcom network service provider for communications system 38 may operate, control, and/or manage a satcom control network such as core network (CN) 20 in network portion 18. CN 20 may sometimes also be referred to herein as satcom network region 20, CN region 20, satcom controller 20, satcom network 20, or satcom service provider equipment 20. CN 20 may be implemented on one or more network nodes and/or terminals of network portion 18 (e.g., one or more servers or other end hosts). In some implementations, CN 20 may be formed from a cloud computing network distributed over multiple underlying physical network nodes and/or terminals distributed across one or more geographic regions. CN 20 may therefore sometimes also be referred to herein as a CN cloud region or satcom network cloud region.

CN 20 may control and coordinate wireless communications between terminals (e.g., end hosts) of terrestrial network 34 and devices 10 via constellation 32. For example, gateways 14 may receive reverse link data from devices 10 via constellation 32 and may route the reverse link data to CN 20. CN 20 may perform any desired processing operations on the reverse link data. For example, CN 20 may identify destinations for the reverse link data and may forward the reverse link data to the identified destinations. CN 20 may also receive forward link data for transmission to devices 10 from one or more terminals or end hosts of terrestrial network 34 (e.g., network portion 18). CN 20 may process the forward link data to schedule the forward link data for transmission to devices 10 via satellite constellation 32. CN 20 may schedule the forward link data for transmission to devices 10 by generating forward link traffic grants for each of the devices that are to receive forward link data. CN 20 may provide the forward link data and the forward link traffic grants to gateways 14. Gateways 14 may transmit the forward link data to devices 10 via constellation 32 according to the forward link traffic grants (e.g., according to a forward link communications schedule that implements the forward link traffic grants). CN 20 may include, be coupled to, and/or be associated with one or more content delivery networks (CDNs) that provide content for delivery to devices 10.

Device 10 is sometimes also referred to herein as UE device 10, UE 10, or electronic device 10. Device 10 may be an electronic device such as a laptop computer, a desktop computer, a computer monitor containing an embedded computer, a tablet computer, a cellular telephone, a media player, or other handheld or portable electronic device, a smaller device such as a wristwatch device, a pendant device, a ring device, a headphone or earpiece device, a device embedded in eyeglasses or other equipment worn on a user's head (e.g., a virtual, augmented, or mixed reality headset, glasses, goggles, helmet, or display device), or other wearable or miniature device, a television, a computer display that does not contain an embedded computer, a gaming device, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, a stylus, a virtual, augmented, or mixed reality user input device, a wireless base station or access point, equipment that implements the functionality of two or more of these devices, or other electronic equipment.

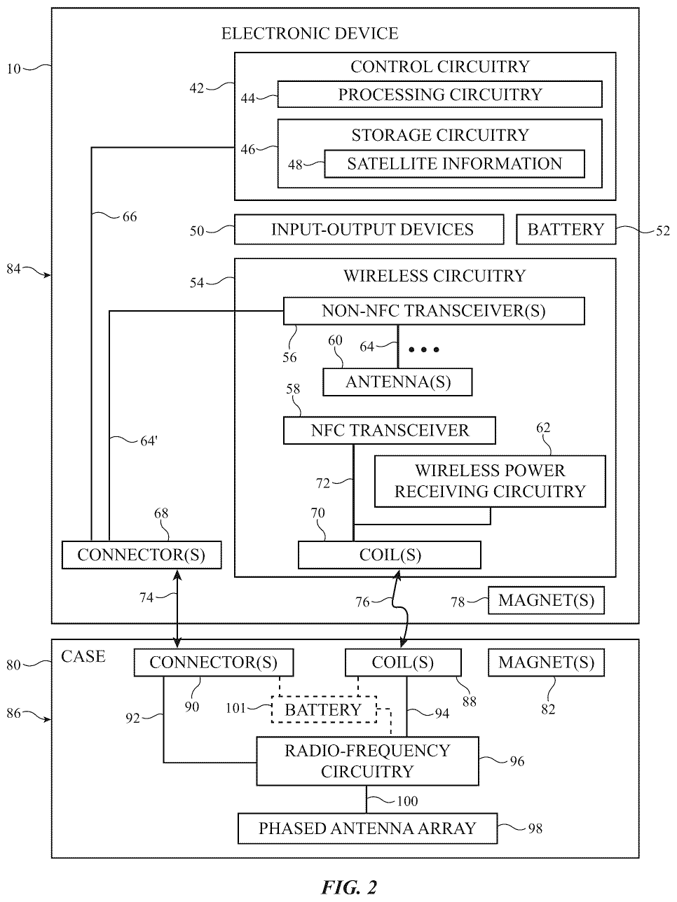

As shown in FIG. 2, device 10 may include components located on or within an electronic device housing such as housing 84. Housing 84, which is sometimes also referred to as a non-removable case for device 10, may be formed of plastic, glass, ceramics, fiber composites, metal (e.g., stainless steel, aluminum, metal alloys, etc.), other suitable materials, or a combination of these materials. In some situations, parts or all of housing 84 may be formed from dielectric or other low-conductivity material (e.g., glass, ceramic, plastic, sapphire, etc.). In other situations, housing 84 or at least some of the structures that make up housing 84 may be formed from metal elements.

Device 10 may include control circuitry 42. Control circuitry 42 may include storage such as storage circuitry 46. Storage circuitry 46 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 46 may include storage that is integrated within device 10 and/or removable storage media.

If desired, storage circuitry 46 may store satellite information 48 associated with constellation 32 (FIG. 1). Satellite information 48, sometimes also referred to as a satellite almanac or satellite ephemeris data, may include information identifying the orbital parameters/position (e.g., orbit information, elevation information, altitude information, inclination information, eccentricity information, orbital period information, trajectory information, right ascension information, declination information, ground track information, etc.), the velocity of some or all of the satellites 12 in constellation 32 (e.g., relative to the surface of Earth), and/or any other desired information associated with satellites 12 and/or the radio-frequency signals 24 handled by satellites 12.

As one example, satellite information 48 may include a two-line element (TLE) for each satellite 12 in constellation 32. A TLE may identify or include information about the orbital motion of a corresponding satellite 12 in constellation 32 (e.g., satellite epoch, first and/or second derivatives of motion, drag terms, etc.). The TLE may be in the format of a text file having two lines or columns that include the set of elements forming the TLE, for example. This example is illustrative and non-limiting and, in general, satellite information 48 may include tables, databases, files, and/or any desired data structures for storing the satellite information or ephemeris data.

Device 10 may receive satellite information 48 upon manufacture and/or assembly of device 10, upon installation of an operating system on device 10, and/or after device 10 has been delivered to an end user (e.g., via a wired and/or wireless link to network portion 18 of FIG. 1). If desired, device 10 may receive updates to satellite information 48 over time (e.g., via network portion 18, from an operator of constellation 32 as the orbital characteristics of satellites 12 change over time, etc.). Control circuitry 42 may use ephemeris data in satellite information 48 to transmit UL signals 24 (FIG. 1) and/or to receive DL signals 26 (FIG. 1) (e.g., to ensure that wireless communications data is conveyed between device 10 at its current location or an expected future location and the current location or the expected future location of one or more satellites 12 in space over device 10 given the motion of the satellite(s) as identified by the ephemeris data).

Control circuitry 42 may include processing circuitry such as processing circuitry 44. Processing circuitry 44 may be used to control the operation of device 10. Processing circuitry 44 may include on one or more processors (e.g., microprocessors, microcontrollers, digital signal processors, host processors, baseband processor integrated circuits, application specific integrated circuits, central processing units (CPUs), graphics processing units (GPUs), etc.). Control circuitry 42 may be configured to perform operations in device 10 using hardware (e.g., dedicated hardware or circuitry), firmware, and/or software. Software code for performing operations on device 10 may be stored on storage circuitry 46 (e.g., storage circuitry 46 may include non-transitory (tangible) computer readable storage media that stores the software code). The software code may sometimes be referred to as program instructions, software, data, instructions, or code. Software code stored on storage circuitry 46 may be executed by processing circuitry 44. If desired, software code may be included within and/or executed by one or more software applications and/or an operating system running on control circuitry 42 (e.g., as executed by an applications processor in processing circuitry 44).

Control circuitry 42 may be used to run software on device 10 such as satellite navigation or mapping applications, internet browsing applications, voice-over-internet-protocol (VOIP) telephone call applications, email applications, media playback applications, gaming applications, operating system functions, etc. To support interactions with external equipment, control circuitry 42 may be used in implementing communications protocols. Communications protocols that may be implemented using control circuitry 42 include internet protocols, wireless local area network (WLAN) protocols (e.g., IEEE 802.11 protocols—sometimes referred to as Wi-Fi®), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 4G (LTE) protocols, 3GPP Fifth Generation (5G) New Radio (NR) protocols, Sixth Generation (6G) protocols, sub-THz protocols, THz protocols, etc.), antenna diversity protocols, satellite navigation system protocols (e.g., global positioning system (GPS) protocols, global navigation satellite system (GLONASS) protocols, Baidu protocols, Galileo protocols, etc.), antenna-based spatial ranging protocols (e.g., radio detection and ranging (RADAR) protocols or other desired range detection protocols for signals conveyed at millimeter and centimeter wave frequencies), satellite communications protocols, and/or any other desired communications protocols. Each communications protocol may be associated with a corresponding radio access technology (RAT) that specifies the physical connection methodology used in implementing the protocol.

Device 10 may include input/output devices 50. Input/output devices 50 are used in providing input to and output from device 10 (e.g., to and/or from an end user of device 10). For example, input/output devices 50 may include one or more displays such as a touch sensitive display, a force sensitive display, a display that is both touch sensitive and force sensitive, or a display without touch or force sensor capabilities. The displays may include a liquid crystal display, a light emitting diode (LED) display, an organic light emitting diode (OLED) display, a micro-LED (uLED) display, etc.

Input/output devices 50 may also include other components such as sensors. Sensors in input/output devices 50 may be used to sense, capture, and/or gather information about device 10 and/or the surroundings of device 10. The sensors may include, for example, image sensors (e.g., cameras), light sensors (e.g., an ambient light sensor (ALS)), light detection and ranging (lidar) sensors, range sensors, proximity sensors (e.g., capacitive proximity sensors, impedance sensors, etc.), infrared sensors (e.g., facial recognition sensors), audio sensors such as microphones and/or ultrasonic sensors (e.g., ultrasonic range sensors), force sensors, moisture sensors, temperature sensors, humidity sensors, fingerprint sensors, pressure sensors, touch sensors, orientation and/or motion sensors such as accelerometers, gyroscopes, compasses, inertial measurement units (IMUs), etc. Input/output devices 50 may also include additional input/output devices such as status indicator lights, speakers, vibrators, keyboards, touch pads, buttons, joysticks, scrolling wheels, audio jacks or other audio port components, digital data port devices (e.g., universal serial bus (USB) ports), magnetic sensors, etc. In some configurations, keyboards, headphones, displays, pointing devices such as trackpads, mice, and joysticks, and other input-output devices may be coupled to device 10 using wired or wireless connections (e.g., some of input-output devices 50 may be peripherals that are coupled to a main processing unit or other portion of device 10 via a wired or wireless link).

Device 10 may also include wireless circuitry 54 to support wireless communications and/or wireless power transfer between device 10 and external equipment. Wireless circuitry 54 may include one or more antennas 60 and one or more non-near-field coupling (non-NFC) transceivers 56 (sometimes also referred to herein as radios 56). Each non-NFC transceiver 56 may include a transmitter that transmits radio-frequency signals, a receiver that receives radio-frequency signals, or both a transmitter and a receiver. Each non-NFC transceiver 56 may convey radio-frequency signals in non-NFC bands over one or more antennas 60 using one or more non-NFC communications protocols. Antenna(s) 60 may convey radio-frequency signals that carry wireless data via propagation in the electromagnetic far-field domain.

If desired, wireless circuitry 54 may also include one or more coils and a near-field communications (NFC) transceiver 58. NFC transceiver 58 may include a transmitter that transmits radio-frequency signals, a receiver that receives radio-frequency signals, or both a transmitter and a receiver. NFC transceiver 58 may convey radio-frequency signals 76 in an NFC band (e.g., at 13.56 MHz) over coil(s) 70 using an NFC communications protocol. Coil(s) 70 may convey radio-frequency signals 76 that carry wireless data via electromagnetic near-field coupling and/or propagation in the electromagnetic near-field domain.

Each non-NFC transceiver 56 and NFC transceiver 58 may include circuitry that operates on signals at baseband frequencies (e.g., baseband processing circuitry, one or more baseband processors, etc.), signal generator circuitry, modulation/demodulation circuitry (e.g., one or more modems), radio-frequency transmitter circuitry, radio-frequency receiver circuitry, mixer circuitry for downconverting radio-frequency signals to baseband frequencies or intermediate frequencies between radio and baseband frequencies and/or for upconverting signals at baseband or intermediate frequencies to radio-frequencies, amplifier circuitry (e.g., one or more power amplifiers and/or one or more low-noise amplifiers (LNAs)), analog-to-digital converter (ADC) circuitry, digital-to-analog converter (DAC) circuitry, control paths, power supply paths, signal paths (e.g., radio-frequency transmission lines, intermediate frequency transmission lines, baseband signal lines, etc.), switching circuitry, filter circuitry, inverters, power converters (e.g., DC-to-DC converters), single-ended signal to differential signal conversion circuitry (e.g., one or more baluns), radio-frequency transformers, and/or any other circuitry for transmitting and/or receiving radio-frequency signals using antenna(s) 60 and/or coil(s) 70. The components of NFC transceiver 58 and each non-NFC transceiver 56 may be mounted onto a respective substrate or integrated into a respective integrated circuit, chip, package, or system-on-chip (SOC). If desired, the components of multiple non-NFC transceivers 36 and/or NFC transceiver 58 may share a single substrate, integrated circuit, chip, package, or SOC.

Antenna(s) 60 may be formed using any desired antenna structures. For example, antenna(s) 60 may include antennas with resonating elements that are formed from loop antenna structures, patch antenna structures, inverted-F antenna structures, slot antenna structures, planar inverted-F antenna structures, helical antenna structures, monopole antennas, dipoles, hybrids of these designs, etc. If desired, one or more antennas 60 may include antenna resonating elements formed from conductive portions of housing 84 (e.g., peripheral conductive housing structures extending around a periphery of a display on device 10). Filter circuitry, switching circuitry, impedance matching circuitry, and/or other antenna tuning components may be adjusted to adjust the frequency response and wireless performance of antenna(s) 60 over time. If desired, multiple antennas 60 may be implemented as a phased array antenna (e.g., where each antenna forms a radiator or antenna element of the phased array antenna, which is sometimes also referred to as a phased antenna array). In these scenarios, the phased array antenna may convey radio-frequency signals within a signal beam. The phases and/or magnitudes of each radiator in the phased array antenna may be adjusted so the radio-frequency signals for each radiator constructively and destructively interfere to steer or orient the signal beam in a particular pointing direction (e.g., a direction of peak signal gain). The signal beam may be adjusted or steered over time. Coil 70 may include one or more turns or loops of conductive traces, wire, or other conductive material. If desired, coil 70 may be disposed on, overlapping, and/or around a ferrite core to optimize electromagnetic coupling between coil 70 and an overlapping coil on an external device.

Each non-NFC transceiver 56 may convey radio-frequency signals using one or more antennas 60 (e.g., antenna(s) 60 may convey the radio-frequency signals for the non-NFC transceiver) and NFC transceiver 58 may convey radio-frequency signals 76 using one or more coils 70 (e.g., coil(s) 70 may convey the radio-frequency signals for the NFC transceiver). The term “convey radio-frequency signals” as used herein means the transmission and/or reception of the radio-frequency signals (e.g., for performing unidirectional and/or bidirectional wireless communications with external wireless communications equipment). Antenna(s) 60 may transmit the radio-frequency signals by radiating the radio-frequency signals into free space (or to free space through intervening device structures such as a dielectric cover layer). Antenna(s) 60 may additionally or alternatively receive the radio-frequency signals from free space (e.g., through intervening devices structures such as a dielectric cover layer). The transmission and reception of radio-frequency signals by antenna(s) 60 each involve the excitation or resonance of antenna currents on an antenna resonating element in the antenna by the radio-frequency signals within the frequency band(s) of operation of the antenna. Current on coil(s) 70 may transmit radio-frequency signals 76 in the near-field domain (e.g., by inducing a magnetic field through an opening in the coil(s) that induces corresponding current on an overlapping coil of an external device). Current can also be induced onto coil(s) 70 by incident radio-frequency signals 76 from an overlapping coil of an external device (e.g., coil(s) 70 may receive radio-frequency signals 76 in the near-field domain).

Each non-NFC transceiver 56 may be coupled to one or more antennas 60 over one or more radio-frequency transmission line paths 64. NFC transceiver 58 may be coupled to coil(s) 70 over one or more radio-frequency transmission line paths 72 (e.g., a differential signal path). Radio-frequency transmission line paths 64 and 72 may each include one or more radio-frequency transmission lines such as coaxial cables, microstrip transmission lines, stripline transmission lines, edge-coupled microstrip transmission lines, edge-coupled stripline transmission lines, transmission lines formed from combinations of transmission lines of these types, etc.

The radio-frequency transmission lines in radio-frequency transmission line paths 64 and 72 may be integrated into rigid and/or flexible printed circuit boards if desired. One or more of the radio-frequency transmission lines may be shared between multiple non-NFC transceivers 56 and/or NFC transceiver 58 if desired. Radio-frequency front end (RFFE) modules may be disposed on one or more of the radio-frequency transmission lines. The radio-frequency front end modules may include substrates, integrated circuits, chips, or packages that are separate from the transceiver(s) and may include filter circuitry, switching circuitry, amplifier circuitry, impedance matching circuitry, radio-frequency coupler circuitry, and/or any other desired radio-frequency circuitry for operating on the radio-frequency signals conveyed over the radio-frequency transmission lines.

Transmission lines in radio-frequency transmission line paths 64 and/or 72 may be integrated into rigid and/or flexible printed circuit boards if desired. In some suitable implementations, radio-frequency transmission line paths 64 and/or 72 may include transmission line conductors (e.g., signal conductors and ground conductors) integrated within multilayer laminated structures (e.g., layers of a conductive material such as copper and a dielectric material such as a resin that are laminated together without intervening adhesive). The multilayer laminated structures may, if desired, be folded or bent in multiple dimensions (e.g., two or three dimensions) and may maintain a bent or folded shape after bending (e.g., the multilayer laminated structures may be folded into a particular three-dimensional shape to route around other device components and may be rigid enough to hold its shape after folding without being held in place by stiffeners or other structures). All of the multiple layers of the laminated structures may be batch laminated together (e.g., in a single pressing process) without adhesive (e.g., as opposed to performing multiple pressing processes to laminate multiple layers together with adhesive).

Non-NFC transceiver(s) 56 may use antenna(s) 60 to transmit and/or receive radio-frequency signals within different frequency bands at radio frequencies (sometimes referred to herein as communications bands or simply as a “bands”). The frequency bands handled by non-NFC transceiver(s) 36 may include satellite communications bands (e.g., the C band, S band, L band, X band, W band, V band, K band, Kₐ band, Kᵤ band, etc.), wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHZ WLAN band (e.g., from 5180 to 5825 MHz), a Wi-Fi® 6E band (e.g., from 5925-7125 MHz), and/or other Wi-Fi® bands (e.g., from 1875-5160 MHz), wireless personal area network (WPAN) frequency bands such as the 2.4 GHz Bluetooth® band or other WPAN communications bands, cellular telephone frequency bands (e.g., bands from about 600 MHz to about 5 GHZ, 3G bands, 4G LTE bands, 5G New Radio Frequency Range 1 (FR1) bands below 10 GHz, 5G New Radio Frequency Range 2 (FR2) bands between 20 and 60 GHz, 6G bands such as sub-THz bands between around 100 GHz and around 10 THz, etc.), other centimeter or millimeter wave frequency bands between 10-300 GHz, near-field communications (NFC) frequency bands (e.g., at 13.56 MHz), satellite navigation frequency bands (e.g., a GPS band from 1565 to 1610 MHz, an L1 band, an L2 band, an L3 band, an LA band, an L5 band, a Global Navigation Satellite System (GLONASS) band, a BeiDou Navigation Satellite System (BDS) band, a Galileo band, etc.), ultra-wideband (UWB) frequency bands that operate under the IEEE 802.15.4 protocol and/or other ultra-wideband communications protocols, communications bands under the family of 3GPP wireless communications standards, communications bands under the IEEE 802.XX family of standards, and/or any other desired frequency bands of interest.

NFC transceiver 58 may use coil(s) 70 to transmit and/or receive radio-frequency signals 76 within an NFC frequency band (e.g., at 13.56 MHz) according to an NFC communications protocol (e.g., a radio-frequency identification (RFID) protocol, an ISO/IEC 14443 protocol, an ISO/IEC 18092 protocol, etc.). If desired, wireless circuitry 54 may also include wireless power receiving circuitry 62 that receives wireless power via coil(s) 70 (e.g., radio-frequency signals 76 may include wireless power signals). Wireless power receiving circuitry 62 may include, for example, one or more rectifiers and/or other circuitry that produce direct current (DC) power based on wireless power signals received via coil(s) 70 (e.g., as transmitted by a wireless power transmitter on a wireless power transmitting device such as a removable battery case, a wireless charging puck, or a wireless charging pad).

Wireless power receiving circuitry 62 may use the generated DC power to power one or more components on device 10 and/or to charge a battery 52 on device 10 (e.g., device 10 may be a wirelessly rechargeable device). Battery 52 may power one or more components on device 10 when device 10 is unplugged from an external power source. Wireless power receiving circuitry 62 may be integrated into NFC transceiver 58 or may be separate from NFC transceiver 58. In some implementations, part of wireless power receiving circuitry 62 may be integrated into NFC transceiver 58 for receiving wireless data transmitted in-band within the wireless power signals received via coil(s) 70 (e.g., by using FSK demodulation, ASK demodulation, or other demodulation schemes to extract a stream of wireless data bits from incident wireless power signals). If desired, coil(s) 70, NFC transceiver 58, and/or wireless power receiving circuitry 62 may be omitted from device 10.

The input-output circuitry on device 10 may also include one or more connectors 68 for interfacing between device 10 and external equipment. The external equipment may be another device such as device 10, a power adapter, a wireless charger (e.g., a wireless charging mat or puck), an accessory or peripheral device (e.g., an external keyboard device, an external trackpad device, an external mouse device, an external microphone device, an external camera device, etc.), a removable device case, external equipment that incorporates the functionality of two or more of these devices, etc. Implementations in which the external equipment is a removable device case such as removable case 80 are described herein as an example. Removable case 80 is sometimes also referred to herein as device case 80, external case 80, accessory case 80, or simply as case 80.

Device 10 may use connector(s) 68 to convey signals from device 10 to the external equipment and/or to convey signals form the external equipment to device 10 (e.g., over a wired electrical path or link). The signals may include radio-frequency signals, baseband signals, analog signals, digital signals, data signals, control signals, power signals such as one or more power supply voltages and/or a ground potential, optical signals, and/or any other signals. Connector(s) 68 may be coupled to control circuitry 42 over control path 66 and/or may be coupled to one or more non-NFC transceivers 56 over radio-frequency transmission line path 64′.

If desired, connector(s) 68 may include one or more connector electrodes. The connector electrode(s) may include conductive or capacitive electrodes that overlap and/or contact corresponding connector electrode(s) in a connector on the external equipment. The connector electrode(s) may convey signals received from control circuitry 42 over control path 66 to the external equipment over the corresponding connector electrode(s) in the connector on the external equipment (e.g., control signals, power signals, power supply voltages, data signals, etc.). The connector electrode(s) may include conductive contact pads or capacitor electrodes, as two examples. When implemented using conductive contact pads, the connector electrode(s) may contact connector electrode(s) in the connector on the external equipment and the signals are conveyed via electrical contact between the connector electrodes in each connector. When implemented as a capacitor electrode, the connector electrode(s) overlap but do not contact connector electrode(s) in the connector on the external equipment (e.g., where both connector electrodes effectively form opposing electrodes or plates of a capacitor) and the signals are conveyed via capacitive coupling between the connector electrodes in each connector.

In practice, connector electrode(s) in connector(s) 68 can produce excessive impedance discontinuity at radio frequencies. If desired, connector(s) 68 may include one or more radio-frequency (RF) connectors that are coupled to non-NFC transceiver(s) 56 over radio-frequency transmission line path 64′. The RF connector(s) may be coupled to (e.g., may be inserted into, may be attached to, may be screwed into, may be fastened to, or may mate with) RF connector(s) in a connector on the external equipment. The RF connector(s) in connector(s) 68 may include coaxial cable connectors, transmission line matching stubs, and/or any other desired RF connector structures that form a smooth impedance transition at radio frequencies between radio-frequency transmission line path 64′ and the RF connector(s) in the connector on the external equipment. Non-NFC transceiver 56 may transmit radio-frequency signals to the external equipment via radio-frequency transmission line path 64′, an RF connector in connector(s) 68, and the corresponding RF connector in the connector on the external equipment. Conversely, non-NFC transceiver 56 may receive radio-frequency signals from the external equipment via the RF connector in the connector on the external equipment, the RF connector in connector(s) 68, and radio-frequency transmission line path 64′.

If desired, connector(s) 68 may include a wired data connector (e.g., a data port such as a universal serial bus (USB) port). The wired data connector may be coupled to and/or may mate with a corresponding wired data connector on the external equipment. The wired data connector may convey control signals, power signals, data signals, etc., between control path 66 and the wired data connector on the external equipment. As another example, connector(s) 68 may include an optical connector that conveys optical signals between an optical path in control path 66 and an optical connector on the external equipment.

In implementations that are described herein as an example, the external equipment includes removable case 80. As shown in FIG. 2, removable case 80 may include one or more connectors 90, one or more coils 88, one or more magnets 82, radio-frequency circuitry 96, phased antenna array (PAA) 98, and optional battery 101 disposed on and/or within a housing body 86 of removable case 80 such as body 86. If desired, connector(s) 90, coil(s) 88, battery 101, and/or magnet(s) 82 may be omitted from removable case 80.

Device 10 may be placed within a recess or cavity in body 86. If desired, one or more magnets 78 on device 10 may attract one or more magnets 82 on removable case 80 to help secure removable case 80 to device 10. Magnets 82 and 78 may include permanent magnets, ferromagnets, electromagnets, or any other desired magnetically attractive structures. Additionally or alternatively, a portion of body 86 (e.g., a sidewall, lip, or bezel portion of body 86) may help to mechanically secure removable case 80 to device 10. Body 86 may be formed from plastic (e.g., injection-molded plastic), rubber, ceramic, glass, sapphire, polymer, silicone, leather, wood, cardboard, paper, carbon fiber, and/or any other desired dielectric materials and/or may be formed from stainless steel, aluminum, titanium, gold, silver, and/or any other desired conductive materials (e.g., metal). When device 10 is mounted to removable case 80, removable case 80 may provide mechanical protection for device 10 and may help to protect device 10 from external contaminants and/or damage (e.g., from drop events or other external forces).

Coil(s) 88 on removable case 80 may include one or more coils similar to coil(s) 70 on device 10. Connectors(s) 90 on removable case 80 may include one or more connector electrodes (e.g., similar to connector electrode(s) in connector(s) 68 of device 10), one or more radio-frequency connectors (e.g., similar to radio-frequency connector(s) in connector(s) 68 of device 10), one or more wired data connectors (e.g., similar to wired data connector(s) in connector(s) 68 of device 10), optical connectors, and/or any other desired connectors. Connector(s) 90 may be coupled to radio-frequency circuitry 96 over signal path 92. Signal path 92 may include, for example, one or more conductive paths (e.g., baseband paths, digital paths, control paths, power paths, etc.) that couple connector electrode(s) and/or wired data connectors in connector(s) 90 to radio-frequency circuitry 96. Additionally or alternatively, signal path 92 may include one or more radio-frequency transmission line paths that couple RF connector(s) in connector(s) 90 to radio-frequency circuitry 96. Coil(s) 88 may be coupled to radio-frequency circuitry 96 over one or more radio-frequency transmission line paths 94.

Radio-frequency circuitry 96 may be coupled to phased antenna array 98 over one or more radio-frequency transmission line paths 100. Radio-frequency circuitry 96 may include radio-frequency front end circuitry such as phase shifters for phased antenna array 98. If desired, radio-frequency circuitry 96 may also include non-NFC transceiver circuitry (e.g., similar to one or more non-NFC transceivers 56), radio-frequency amplifier circuitry, filter circuitry, switching circuitry, wireless power transmitting circuitry, and/or NFC transceiver circuitry. If desired, NFC transceiver 58 on device 10 may use coil(s) 70 to transmit radio-frequency signals 76 that carry wireless data to coil(s) 88 on removable case 80. Coil(s) 88 may pass the radio-frequency signals to NFC receiver circuitry in radio-frequency circuitry 96. Radio-frequency circuitry 96 perform communications using phased antenna array 98 based on the wireless data in radio-frequency signals 76. For example, radio-frequency circuitry 96 may include a satellite communications modem in case 80 that conveys the wireless data in radio-frequency signals 76 with the satellite via phased antenna array 98 (e.g., the satellite communications modem may modulate the wireless data from radio-frequency signals 76 onto radio-frequency signals transmitted by phased antenna array 98 and/or may demodulate wireless data in radio-frequency signals received by phased antenna array 98 for transmission to device 10 using radio-frequency signals 76.

If desired, removable case 80 may be used to wirelessly charge battery 52 on device 10. For example, wireless power transmitting circuitry in radio-frequency circuitry 96 may generate wireless power signals based on charge stored on battery 101. Battery 101 may, for example, be charged by an external power source when connector(s) 90 are coupled to the external power source (e.g., an AC power source such as a power adapter, wall outlet, etc.) and/or may be charged by an external wireless power transmitting device that transmits wireless power signals to coil(s) 88. Radio-frequency circuitry 96 may transmit the wireless power signals to coil(s) 88 over radio-frequency transmission line path 94. Coil(s) 88 may transmit the wireless power signals in radio-frequency signals 76. Coil(s) 70 on device 10 may receive the wireless power signals and wireless power receiving circuitry 62 may charge battery 52 based on the received wireless power signals.

When device 10 is mounted to (received by) removable case 80, one or more connectors 68 on device 10 may couple to, contact, overlap, connect to, and/or mate with one or more corresponding connectors 90 on removable case 80. Device 10 and removable case 80 may convey signals 74 between connector(s) 68 and connector(s) 90. Signals 74 may be radio-frequency signals, control signals, data signals, power signals (e.g., one or more power supply voltages, reference voltages, etc.), and/or any other desired signals. Signals 74 may be conveyed over a wired link or a capacitive link between connector(s) 68 and connector(s) 90, as two examples.

While control circuitry 42 is shown separately from wireless circuitry 54 in the example of FIG. 2 for the sake of clarity, non-NFC transceiver(s) 56 and/or NFC transceiver 58 may include processing circuitry that forms a part of processing circuitry 44 and/or storage circuitry that forms a part of storage circuitry 46 of control circuitry 42 (e.g., portions of control circuitry 42 may be implemented on wireless circuitry 54). As an example, control circuitry 42 may include baseband circuitry or other control components that form a part of wireless circuitry 54. The baseband circuitry may, for example, access a communication protocol stack on control circuitry 42 (e.g., storage circuitry 46) to: perform user plane functions at a PHY layer, MAC layer, RLC layer, PDCP layer, SDAP layer, and/or PDU layer, and/or to perform control plane functions at the PHY layer, MAC layer, RLC layer, PDCP layer, RRC, layer, and/or non-access stratum layer.

If care is not taken, the long radio-frequency propagation lengths between device 10 on Earth and satellites 12 in space (FIG. 1) can make communications between device 10 and satellites 12 challenging. For example, radio-frequency signals conveyed between non-NFC transceiver(s) 56 and satellites 12 can be subject to substantial signal attenuation while propagating through the atmosphere between satellites 12 and device 10. In addition, when device 10 is mounted to removable case 80, portions of the body 86 of removable case 80 may overlap and/or block some or all of antenna(s) 60, which can produce further signal attenuation in communicating with satellites 12. To help mitigate these issues, device 10 may utilize phased antenna array 98 on removable case 80 to convey or relay radio-frequency signals between device 10 and satellites 12. Put differently, the radio-frequency path for radio-frequency signals conveyed by non-NFC transceiver(s) 56 may be distributed between device 10 and removable case 80. This may serve to eliminate signal attenuation produced by body 86 of removable case 80. In addition, phased antenna array 98 may perform beamforming on the radio-frequency signals to boost the gain of the radio-frequency signals (e.g., by as much as 5-10 dB relative to antennas 60 on device 10), helping to counteract atmospheric signal attenuation between removable case 80 and satellites 12.

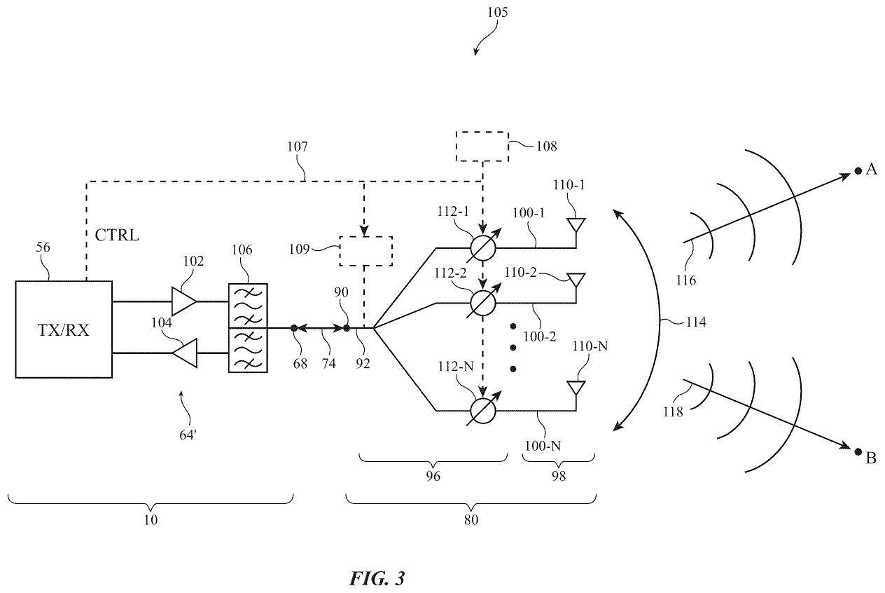

FIG. 3 is a circuit diagram showing an example of a radio-frequency path 105 that may be distributed between a non-NFC transceiver (TX/RX) 56 on device 10 and phased antenna array 98 on removable case 80. As shown in FIG. 3, radio-frequency path 105 (sometimes also referred to herein as radio-frequency chain 105) may include radio-frequency transmission line path 64′ extending from a non-NFC transceiver 56 to a connector 68 on device 10. If desired, amplifier circuitry such as power amplifier 102 and/or low noise amplifier 104 and filter circuitry 106 (e.g., a duplexer or diplexer) may be disposed on radio-frequency transmission line path 64′ between non-NFC transceiver 56 and connector 68.

Radio-frequency path 105 may also include a radio-frequency transmission line path in signal path 92, radio-frequency circuitry 96, radio-frequency transmission line paths 100, and phased antenna array 98 on removable case 80. The radio-frequency transmission line path in signal path 92 may couple connector 90 to radio-frequency circuitry 96. Radio-frequency circuitry 96 may couple the radio-frequency transmission line path in signal path 92 to phased antenna array 98 over radio-frequency transmission line paths 100. In this example, connectors 68 and 90 may be RF connectors and the signals 74 conveyed between connectors 68 and 90 may be radio-frequency signals.

As shown in FIG. 3, phased antenna array 98 may include a set of N antennas 110 (e.g., antennas that convey radio-frequency signals in the far-field domain similar to antenna(s) 60 of FIG. 2). N may be any desired integer greater than or equal to two. Phased antenna array 98 may include, for example, a handful, dozens, or hundreds of antennas 110. While referred to herein as a phased antenna array 98 of antennas 110, phased antenna array 98 is sometimes also referred to as a phased array antenna having N antenna elements 110 or antenna radiators 110.

Each antenna 110 in phased antenna array 98 may be coupled to a corresponding radio-frequency transmission line path 100 (e.g., a first antenna 110-1 may be coupled to a first radio-frequency transmission line path 100-1, a second antenna 110-2 may be coupled to a second radio-frequency transmission line path 100-2, an Nth antenna radiator 110-N may be coupled to an Nth radio-frequency transmission line path 100-N, etc.). Each radio-frequency transmission line path 100 may be coupled the to radio-frequency transmission line path in signal path 92 through radio-frequency circuitry 96. If desired, a radio-frequency signal combiner may couple each of the N radio-frequency transmission line paths 100 to the radio-frequency transmission line path in signal path 92. Each antenna 110 may be separated from one or more adjacent antennas 110 in phased antenna array 98 by a predetermined distance that allows for beamforming (e.g., approximately one-half the wavelength of operation of antennas 110). Radio-frequency circuitry 96 may include a respective phase and magnitude controller 112 disposed on each radio-frequency transmission line path 100 (e.g., radio-frequency transmission line path 100-1 may include a first phase and magnitude controller 112-1, radio-frequency transmission line path 100-2 may include a second phase and magnitude controller 112-2, radio-frequency transmission line path 100-N may include an Nth phase and magnitude controller 112-N, etc.).

During signal transmission, non-NFC transceiver 56 may transmit radio-frequency signals over radio-frequency transmission line path 64′. The radio-frequency signals may, for example, carry wireless data (e.g., reverse link data) for transmission to a satellite 12 of constellation 32 (FIG. 1). Power amplifier 102 may amplify the radio-frequency signals, which are transmitted to connector 68 over radio-frequency transmission line path 64′ through filter 106. Connector 68 (e.g., a first RF connector) may pass the radio-frequency signals to connector 90 (e.g., a second RF connector) as signals 74. Connector 90 may pass the radio-frequency signals onto the radio-frequency transmission line path in signal path 92, which passes the radio-frequency signals onto the N radio-frequency transmission line paths 100 in parallel. Phase and magnitude controllers 112 may apply different phase shifts to the radio-frequency signals on radio-frequency transmission line paths 100. The antennas 110 in phased antenna array 98 may radiate the radio-frequency signals with the corresponding phase shifts to transmit the radio-frequency signals to a satellite 12 within a corresponding signal beam.

Conversely, during signal reception, radio-frequency signals may be incident on device 10 from a satellite 12. Phased antenna array 98 may receive the radio-frequency signals and may pass the received radio-frequency signals onto the radio-frequency transmission line path in signal path 92 through radio-frequency transmission line paths 100 and phase and magnitude controllers 112. Phase and magnitude controllers 112 may apply different phase shifts to the radio-frequency signals on radio-frequency transmission line paths 100 such that the radio-frequency signals coherently sum at the radio-frequency transmission line path in signal path 92. Connector 90 may pass the radio-frequency signals to connector 68 as signals 74. Connector 68 may pass the radio-frequency signals onto radio-frequency transmission line path 64′. Filter 106 may pass the received radio-frequency signals to low noise amplifier 104, which amplifies and passes the received radio-frequency signals to non-NFC transceiver 56 for downconversion, decoding, and demodulation.

The use of multiple antennas 110 in phased antenna array 98 may allow beam forming arrangements to be implemented in which the relative phases and magnitudes (amplitudes) of the radio-frequency signals conveyed by the antennas are controlled by phase and magnitude controllers 112. For example, during signal transmission, phase and magnitude controllers 112 may apply/impart different phases and/or magnitudes to the radio-frequency signals transmitted over radio-frequency transmission line paths 100 that cause the radio-frequency signals, upon transmission by antennas 110, to constructively and destructively interfere in a manner that forms a signal beam oriented in a particular direction (e.g., a beam pointing direction). The signal beam exhibits a peak gain in the beam pointing direction (e.g., oriented at a corresponding beam pointing angle) and reduced gain away from the beam pointing direction (e.g., the beam may exhibit a beam width associated with the physical spread of the electromagnetic energy associated with the signals).

Conversely, during signal reception, radio-frequency signals are incident upon phased antenna array 98 from a particular direction. The wavefronts of the radio-frequency signals will be incident upon different antenna radiators 30 at slightly different times, given by the geometry of phased antenna array 98 and the incident angle of the signals. Phase and magnitude controllers 112 apply different phases and magnitudes to the signals received across phased antenna array 98 in a manner that causes the received signals to coherently sum when combined together (e.g., at the radio-frequency transmission line path in signal path 92). This allows the combined coherent signal to exhibit much higher gain than the signal as received by any single antenna 110.

Phase and magnitude controllers 112 are sometimes also referred to collectively herein as beamforming circuitry 112. Beamforming circuitry 112 may receive control signals that cause phase and magnitude controllers 112 to form a corresponding signal beam (e.g., for transmitting radio-frequency signals in a particular beam pointing direction or for receiving radio-frequency signals from a particular beam pointing direction while allowing the received radio-frequency signals to coherently combine). Each phase and magnitude controller 112 may, for example, receive a different respective control signal that sets the phase and magnitude imparted by that phase and magnitude controller to particular values. The control signals may contain, identify, and/or represent corresponding beamforming coefficients or weights, for example. The beamforming coefficients or weights may be stored at a codebook on device 10 and/or removable case 80.

As one example, non-NFC transceiver 56 (or corresponding baseband circuitry) may generate control signals CTRL that set the phase and magnitude settings of the phase and magnitude controllers 112 on removable case 80. In this example, non-NFC transceiver 56 (or the corresponding baseband circuitry) may transmit control signals CTRL to phase and magnitude controllers 112 over a control path 107 that extends between device 10 and removable case 80. Control path 107 may, for example, include a wired or capacitive path that includes control path 66 on device 10 (FIG. 1), a connector electrode and/or wired data connector in the connector(s) 68 on device 10 (FIG. 2), a connector electrode and/or wired data connector in the connector(s) 90 on removable case 80 (FIG. 2), and a control path in signal path 92 on removable case 80 (FIG. 2). As another example, control path 107 may be an NFC path that includes NFC transceiver 58, radio-frequency transmission line path 72, and coil(s) 70 on device 10, radio-frequency signals 76, coil(s) 88, radio-frequency transmission line path 94, and NFC circuitry in radio-frequency circuitry 96 on removable case 80 (e.g., NFC radio-frequency signals 76 may be used by device 10 to control beamforming on removable case 80). This may, for example, allow the calculation and selection of suitable phase and magnitude settings for phase and magnitude controllers 112 (e.g., beamforming logic and/or calculation operations) to be offloaded to device 10. This may minimize the processing logic, power consumption, complexity, and cost of removable case 80 while also allowing beamforming to be adjusted in real time to match the communication needs of device 10 as rapidly as possible.

Control signals CTRL may adjust the phase and magnitude settings of phase and magnitude controllers 112 to steer or scan the direction of the signal beam formed by phased antenna array 98 over time, as shown by arrow 114. For example, at a first time, control signals CTRL may control phase and magnitude controllers 112 to exhibit a first set of phase and magnitude settings that configure phased antenna array 98 to form a first signal beam in the direction of arrow 116 (e.g., for conveying radio-frequency signals with a satellite 12 at location A). At a second time, control signals CTRL may control phase and magnitude controllers 112 to exhibit a second set of phase and magnitude settings that configure phased antenna array 98 to form a second signal beam in the direction of arrow 118 (e.g., for conveying radio-frequency signals with a satellite 112 at location B). In general, phased antenna array 98 may have any desired number of formable signal beams in any desired directions, from a boresight direction (e.g., having a beam pointing direction in a surface normal to the plane of antennas 110) to directions off of boresight.

The example of FIG. 3 is illustrative and non-limiting. As another example, removable case 80 may include processing circuitry 108 that generates phase and magnitude settings for phase and magnitude controllers 112 based on a control signal CTRL received from device 10 over control path 107 (e.g., beam selection and/or phase and magnitude calculations need not be offloaded from removable case 80 and may be distributed between device 10 and removable case 80 in any desired manner). As another example, phase and magnitude controllers 112 may be disposed on device 10 and may be coupled between connector 68 and non-NFC transceiver 56 (e.g., beamforming may be completely offloaded onto device 10). As another example, radio-frequency circuitry 96 on removable case 80 may include a transceiver 109 (e.g., an NFC or non-NFC modem or radio) that conveys radio-frequency signals over phased antenna array 98. In this example, transceiver 109 may receive wireless data (e.g., baseband data in control signals CTRL) to transmit to satellite 12 over control path 107 and may transmit wireless data (e.g., baseband data) received from satellite 12 to device 10 over control path 107 (e.g., where control path 107 includes a wired path, a capacitive path, an RF path, and/or an NFC path between device 10 and removable case 80). In implementations where control path 107 includes an NFC path, the NFC path in control path 107 may include NFC transceiver 58 on device 10 (FIG. 2), path 72 on device 10 (FIG. 2), coil(s) 70 on device 10 (FIG. 2), radio-frequency signals 76, coil(s) 88 on case 80 (FIG. 2), path 94 on case 80 (FIG. 2), NFC transceiver circuitry in radio-frequency circuitry 96 on case 80 (FIG. 2), and a signal path between the NFC transceiver circuitry and a satellite communications modem. In these implementations, transceiver 109 may include the satellite communications modem. The satellite communications modem may receive wireless data for transmission to the satellite over the NFC path in control path 107 (e.g., via coils 88 and 70 and radio-frequency signals 76 of FIG. 2). The satellite communications modem may modulate the wireless data received over the NFC path onto radio-frequency signals that are then transmitted over signal path 92 and phased antenna array 98. Conversely, the satellite communications modem may demodulate wireless data received from the satellite over phased antenna array 98 and signal path 92 and may then transmit the demodulated wireless data to device 10 over the NFC path. In these implementations, non-NFC transceiver 56 need not convey signals 74 with case 80 if desired.

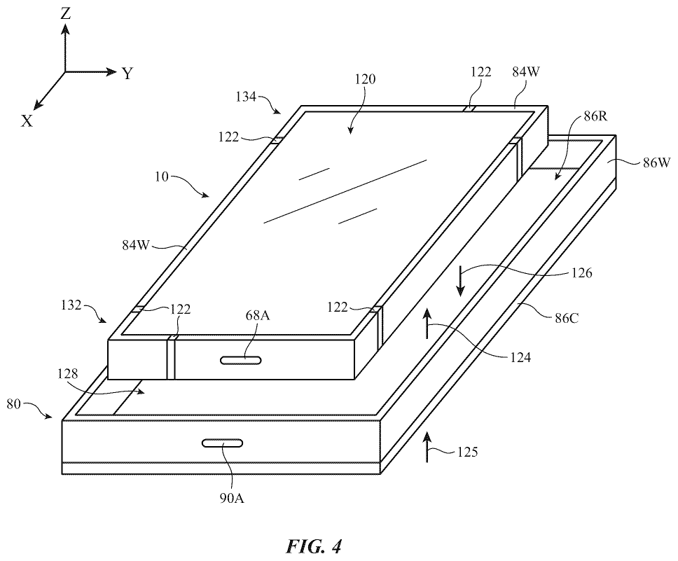

FIG. 4 is a perspective view showing one example of how device 10 may be mounted to removable case 80. As shown in FIG. 4, electronic device 10 may have a housing 84 with a substantially rectangular outline. Removable case 80 may have a similar shape to electronic device 10 and may have a body 86 with a substantially rectangular recess 128 that matches the outline of device 10. This is illustrative and, in general, housing 84 of device 10 and recess 128 of removable case 80 may have any desired shapes. Recess 128 is sometimes also referred to herein as device cavity 128 or device receiving volume 128.

Device 10 may have a display such as display 120. Display 120 may be mounted to the front face of device 10. Display 120 may be a touch screen that incorporates capacitive touch electrodes or may be insensitive to touch. Display 120 may include image pixels formed from light-emitting diodes (LEDs), organic LEDs (OLEDs), plasma cells, electrowetting pixels, electrophoretic pixels, liquid crystal display (LCD) components, or other suitable image pixel structures. A display cover layer such as a layer of clear glass or plastic, a layer of sapphire, a transparent dielectric such as clear ceramic, fused silica, transparent crystalline material, or other materials or combinations of these materials may cover the surface of display 120. If desired, one or more buttons, cameras, sensors, and/or other components may overlap and/or pass through openings in the cover layer. The cover layer may also have other openings such as an opening for a speaker port or a microphone port.

The housing 84 of device 10 may include peripheral conductive housing structures 84W (sometimes also referred to herein as conductive housing sidewalls 84W). Peripheral conductive housing structures 84W may run around the periphery of device 10 and display 120. In configurations in which device 10 and display 120 have a rectangular shape with four edges, peripheral conductive housing structures 84W may be implemented using peripheral housing structures that have a rectangular ring shape with four corresponding edges (as an example). Peripheral conductive housing structures 84W or part of peripheral conductive housing structures 84W may serve as a bezel for display 120 (e.g., a cosmetic trim that surrounds all four sides of display 120 and/or that helps hold display 120 to device 10). Peripheral conductive housing structures 84W may also, if desired, form sidewall structures for device 10 (e.g., by forming a metal band with vertical sidewalls, by curved sidewalls that extend upwards as integral portions of a rear housing wall, etc.).

If desired, peripheral housing structures 84W may include one or more dielectric-filled gaps 122 that divide peripheral conductive housing structures 84W into two or more segments. Different segments of peripheral conductive housing structures 84W may form some or all of antenna resonating elements for one or more antennas 60 in device 10 (FIG. 1). The rear face of housing 84 may include a planar rear housing wall (not shown). The rear housing wall may be formed from glass, metal, ceramic, sapphire, and/or other materials. The rear housing wall may lie in a plane that is parallel to display 120. In configurations for device 10 in which the rear housing wall is formed from metal, it may be desirable to form parts of peripheral conductive housing structures 84W as integral portions of the housing structures forming the rear housing wall. For example, a rear housing wall of device 10 may be formed from a planar metal structure and portions of peripheral conductive housing structures 84W on the sides of housing 12 may be formed as vertically extending integral metal portions of the planar metal structure. Housing structures such as these may, if desired, be machined from a block of metal and/or may include multiple metal pieces that are assembled together to form housing 12 (e.g., in a unibody configuration).

It is not necessary for peripheral conductive housing structures 84W to have a uniform cross-section. For example, the top portion of peripheral conductive housing structures 84W may, if desired, have an inwardly protruding lip that helps hold display 120 in place. The bottom portion of peripheral conductive housing structures 84W may also have an enlarged lip (e.g., in the plane of the rear surface of device 10). Peripheral conductive housing structures 84W may have substantially straight vertical sidewalls, may have sidewalls that are curved, or may have other suitable shapes. In some configurations (e.g., when peripheral conductive housing structures 84W serve as a bezel for display 120), peripheral conductive housing structures 84W may run around the lip of housing 12 (e.g., peripheral conductive housing structures 84W may cover only the edge of housing 12 that surrounds display 120 and not the rest of the sidewalls of housing 12).

Removable case 80 may have a body such as body 86. Body 86 may include a main body portion such as main body 86R (e.g., a lateral wall of removable case 80 extending parallel to the X-Y plane), a movable cover such as cover 86C coupled to main body 86R, and sidewall structures coupled to main body 86R such as peripheral sidewalls 86W. Cover 86C may be coupled to main body 86R, device 10, and/or peripheral sidewalls 86W at one or more points or locations. Peripheral sidewalls 86W may extend, from body 86, upwards and away from cover 86C. Peripheral sidewalls 86W may laterally surround recess 128. A rear edge of recess 128 may be defined by main body 86R if desired.

When mounting device 10 to removable case 80, device 10 may be inserted into recess 128 (e.g., removable case 80 may receive device 10 within recess 128). Peripheral sidewalls 86W may laterally surround peripheral conductive housing structures 84W of device 10. If desired, peripheral sidewalls 86W may exert a mechanical force on device 10 to help hold device 10 within recess 128. If desired, one or more magnets 78 on device 10 (FIG. 1) may attract one or more magnets 82 on removable case 80 (FIG. 1) to help secure removable case 80 to device 10. Since removable case 80 is removable, device 10 may be removed from removable case 80 by extracting device 10 from recess 128 and/or by otherwise removing removable case 80 from device 10. Cover 86C may move or rotate relative to the rear housing wall of device 10, main body 86R, and/or peripheral sidewalls 86W. If desired, cover 86C and/or main body 86R may include a cavity that receives a stylus for device 10. If desired, cover 86C and/or main body 86R may be used to help prop, wedge, or stand device 10 up in a vertical or horizontal orientation on an underlying surface such as a table or desk.

If desired, the connector(s) 90 in removable case 80 (FIG. 2) may include a wired data connector such as wired data connector 90A (e.g., a USB port or other wired data port). Wired data connector 90A may, for example, be disposed on a lower sidewall in peripheral sidewalls 86W of removable case 80. The connector(s) 68 in device 10 (FIG. 2) may also include a wired data connector such as wired data connector 68A (e.g., a USB port or other wired data port). Wired data connector 68A may be coupled to wired data connector 90A when device 10 is inserted into recess 128. As one example, wired data connector 68A may include a female data connector (e.g., a female USB port) and wired data connector 90A includes a male data connector (e.g., a male USB port) that mates with the female data connector when device 10 is mounted to removable case 80. If desired, wired data connector 90A on removable case 86W may also include a female data connector that mates with an external male data connector for an external device such as a charging device or adapter. Alternatively, wired data connector 90A may be replaced with a slot or opening in the lower sidewall of peripheral sidewalls 86W that allows a male data connector from an external device to pass through peripheral sidewalls 86W to mate with the female data connector on device 10.

Connector(s) 90, coil(s) 88, magnet(s) 82, radio-frequency circuitry 96, phased antenna array 98, radio-frequency transmission line paths 94 and 100, and optional battery 101 (FIG. 2) may be disposed on and/or within main body 86R, cover 86C, and/or peripheral sidewalls 86W of removable case 80. In implementations that are described herein as an example, the antennas 110 in phased antenna array 98 (FIG. 3) may be disposed on and/or within cover 86C of removable case 80.

The example of FIG. 4 is illustrative and non-limiting. If desired, some or all of cover 86C may overlap, cover, or protect display 120 at the front face of device 10 in one or more orientations of cover 86C (e.g., cover 86C may be movable between at least a first orientation where the movable cover extends parallel to the rear housing wall of device 10 and a second orientation where the movable cover extends over display 120 around the sidewalls of body 86). If desired, peripheral sidewalls 86W may be omitted from body 86 of removable case 80. In this example, magnets 78 and 82 (FIG. 2) may serve to attach or affix main body 86R and/or cover 86C to device 10 when device 10 is mounted to removable case 80. If desired, main body 86R may be omitted from body 86 of removable case 80. In this example, peripheral sidewalls 86W and/or magnets 78/82 may be used to secure removable case 80 to device 10. If desired, both main body 86R and peripheral sidewalls 86W may be omitted from body 86 of removable case 80. In this example, magnets 78/82 may secure cover 86C to the rear housing wall of device 10. Cover 86C may include a stationary portion that is coupled or secured to the rear housing wall of device 10 and may include one or more movable portions that move relative to the rear housing wall of device 10 and the stationary portion of cover 86C. Cover 86C may be substantially planar, may have folding portions, or may have other shapes. As another example, removable case 80 (e.g., peripheral sidewalls 86W and/or main body 86R) may have the shape of a sleeve that slides over device 10. As another example, removable case 80 may be mounted to only one end of device 10. Device 10 and/or removable case 80 may have other suitable shapes.

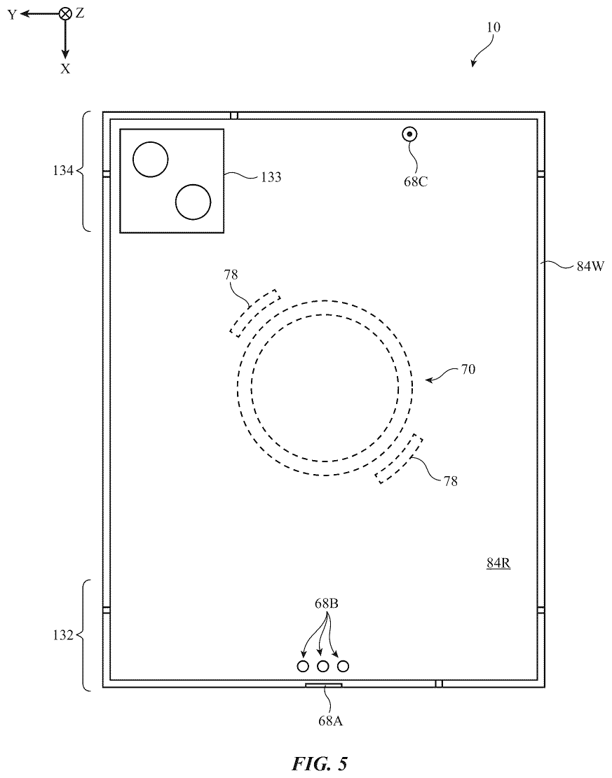

FIG. 5 is an exterior rear view of device 10 (e.g., as viewed in the direction of arrow 124 of FIG. 4). As shown in FIG. 5, the housing 84 of device 10 may include a rear housing wall 84R. Rear housing wall 84R may extend between the lateral edges of device 10 defined by peripheral conductive housing structures 84W (e.g., parallel to the X-Y plane). Device 10 may have an upper end 134 and an opposing lower end 132.

If desired, one or more segments of peripheral conductive housing structures 84W may form part of one or more antennas at upper end 134 of device 10 and one or more segments of peripheral conductive housing structures 84W may form part of one or more antennas at lower end 132 of device 10. If desired, device 10 may include a camera module 133 that protrudes through an opening in rear housing wall 84R at upper end 134 (e.g., at an upper corner of device 10). Camera module 133 may be, for example, a front-facing camera module that includes one or more image sensors, a flash module, and/or any other desired sensors.

Device 10 may include connectors 68 at different locations for interfacing with removable case 80. For example, wired data connector 68A of device 10 may be formed in a sidewall of peripheral conductive housing structures 84W at lower end 132. As another example, device 10 may include a set of one or more connector electrodes 68B (e.g., at lower end 132). Connector electrodes 68B may overlap and/or contact corresponding connector electrodes on removable case 80. Connector electrodes 68B and wired data connector 68A may be coupled to control circuitry 42 on device 10 over control path 66 (FIG. 2).

As another example, device 10 may include a set of one or more RF connectors such as RF connector 68C. RF connector 68C may, for example, protrude through an opening in rear housing wall 84R at upper end 134 of device 10. RF connector 68C may be coupled to non-NFC transceiver(s) 56 in device 10 over radio-frequency transmission line path 64′ (FIG. 2). If desired, RF connector 68C may be located near an antenna feed for an antenna that includes a segment of peripheral conductive housing structures 84W at upper end 134 to minimize routing complexity and loss within device 10.

If desired, device 10 may include coil(s) 70 disposed within a central region of device 10 (e.g., between ends 134 and 132). Coil(s) 70 may, for example, overlap a dielectric portion of rear housing wall 84R and/or a dielectric window in a metal wall used to form rear housing wall 84R. Coil(s) 70 may convey radio-frequency signals 76 (FIG. 2) with coil(s) 88 on removable case 80 (FIG. 2) through rear housing wall 84R when device 10 is mounted to removable case 80. The radio-frequency signals 76 conveyed by coil(s) 70 may include control signals that set the phase and magnitude settings of the phase and magnitude controllers 112 on removable case 80 (FIG. 3), wireless power signals transmitted by coil(s) 88 on removable case 80 to charge battery 52 on device 10, and/or any other wireless data (e.g., NFC data, RFID data, wireless data to be transmitted by phased antenna array 98, wireless data received by phased antenna array 98, etc.).

If desired, one or more magnets 78 may be disposed around the periphery of coil 70. Magnets 78 may, for example, help to lock coil(s) 88 on removable case 80 in place overlapping coil(s) 70 to maximize electromagnetic coupling between coil(s) 88 and coil(s) 70. If desired, RF connector 68C, connector electrode(s) 68B, wired data connector 68A, coil(s) 70, and/or magnets 78 may be omitted. Device 10 may have other form factors and/or components at rear housing wall 84R.

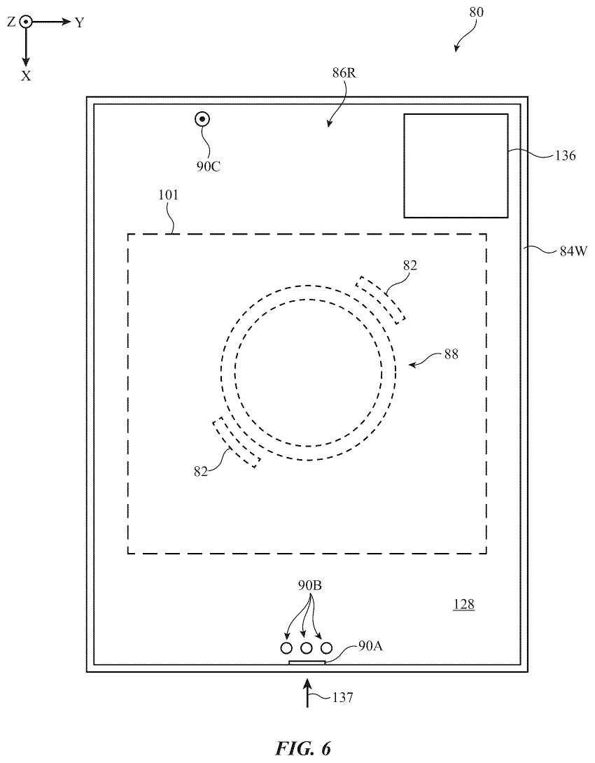

FIG. 6 is an exterior front view of removable case 80 (e.g., as viewed in the direction of arrow 126 of FIG. 4). As shown in FIG. 6, main body 86R of removable case 80 may extend between peripheral sidewalls 86W from a lower end to an upper end of removable case 80. Removable case 80 may include wired data connector 90A on a sidewall of peripheral sidewalls 86W at the lower end of removable case 80. Main body 86R and cover 86C (FIG. 4) of removable case 80 may include an opening 136 at the upper end of removable case 80 and that aligns with camera module 133 on device 10 (FIG. 5) when device 10 is mounted to or received by removable case 80. If desired, wired data connector 90A may receive a mating external connector in the direction of arrow 138. Wired data connector 90A may mate with wired data connector 68A (FIG. 5) on device 10 when device 10 is mounted to removable case 80.

If desired, removable case 80 may include a set of one or more connector electrodes 90B at the lower end of the removable case (e.g., overlapping portion 86C-2 of cover 86C when in the closed configuration). Connector electrode(s) 90B may overlap and/or contact connector electrodes 68B on device 10 when device 10 is received by removable case 80. Connector electrodes 90B and wired data connector 90A may be coupled to radio-frequency circuitry 96 on removable case 80 over signal path 92 (FIG. 2).

As another example, removable case 80 may include a set of one or more RF connectors such as RF connector 90C. RF connector 90C may, for example, protrude through an opening in removable case 80 at the upper end of the removable case. RF connector 90C may be coupled to radio-frequency circuitry 96 in removable case 80 over a radio-frequency transmission line path in signal path 92 (FIG. 2). RF connector 90C may be coupled to (e.g., may be attached to, may overlap, may capacitively couple to, may be screwed into, may be pinned into, may mate with, etc.) RF connector 68C on device 10 when device 10 is mounted to removable case 80.

If desired, removable case 80 may include coil(s) 88 disposed within a central region of removable case 80 (e.g., between the upper and lower ends). Coil(s) 88 may overlap coil(s) 70 on device 10 when device 10 is mounted to removable case 80. Coil(s) 88 may convey radio-frequency signals 76 (FIG. 2) with coil(s) 70 on device 10 (FIG. 5) when device 10 is mounted to removable case 80. Radio-frequency signals 76 may include wireless power, control signals CTRL (FIG. 2) (e.g., for setting the phases and magnitudes produced by phase and magnitude controllers 112), and/or may include wireless data conveyed over an NFC path between case 80 and device 10 by a satellite communications modem in transceiver 109 (FIG. 3). In implementations where case 80 includes a satellite communications modem in transceiver 109, a signal path may couple coil(s) 80 to the satellite communications modem, which is coupled to phase and magnitude controllers 112 over a corresponding signal path 92. If desired, one or more magnets 82 may be disposed around the periphery of coil(s) 88. Magnets 82 may, for example, help to lock coil(s) 88 in removable case 80 in place overlapping coil(s) 70 on device 10 to maximize electromagnetic coupling between coil(s) 88 and coil(s) 70. If desired, RF connector 90C, connector electrode(s) 90B, wired data connector 90A, coil(s) 88, and/or magnets 82 may be omitted. Removable case 80 may have other form factors. If desired, main body 86R may be omitted, in which case the components shown overlapping main body 86R of FIG. 6 may instead by disposed on or within cover 86C of FIG. 4. If desired, peripheral sidewalls 86W may be omitted. If desired, battery 101 may be disposed within main body 86R and overlapping the central region of removable case 80 (e.g., coil(s) 88). Battery 101 may be omitted from removable case 80 if desired.

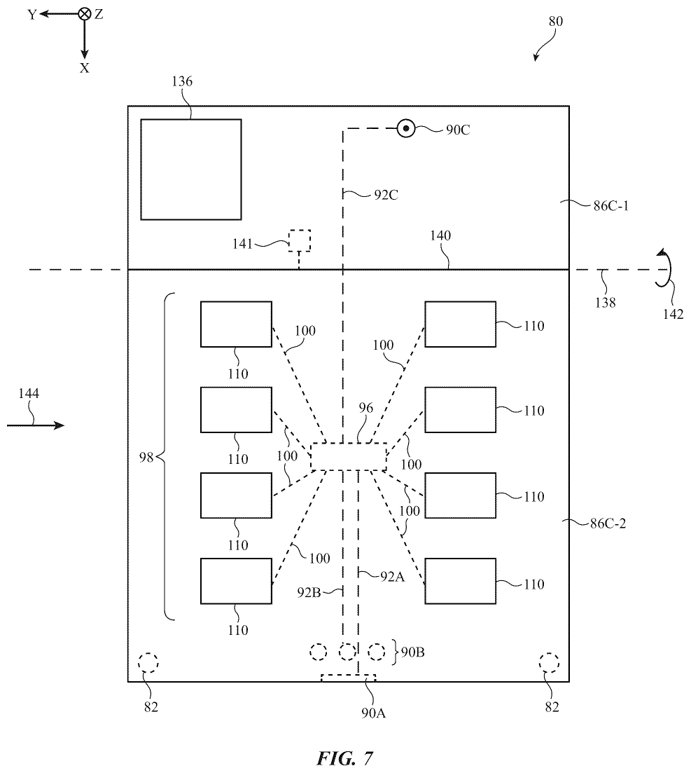

FIG. 7 is an interior rear view of removable case 80 (e.g., as viewed in the direction of arrow 125 of FIG. 4). As shown in FIG. 7, cover 86C may extend between the lateral edges of removable case 80. Cover 86C may include at least a first portion 86C-1 and a second portion 86C-2 that is coupled to portion 86C-1 by joint 140. Portion 86C-1 may be substantially planar, may be stationary relative to device 10, may be affixed to main body 86R (FIG. 6) of removable case 80 or the rear housing wall of device 10, and may be substantially rigid. Joint 140 may be formed from an elastic, foldable, and/or bendable portion of removable case 80 and/or may include a hinge.

Portion 86C-2 may be substantially planar and may be substantially rigid. Portion 86C-2 may be a movable portion of cover 86C that is movable or rotatable with respect to portion 86C-1 about linear axis 137, as shown by arrow 142. Linear axis 137 may extend through joint 140. In the example of FIG. 7, joint 140 and axis 137 extend parallel to the width of device 10 (e.g., orthogonal to the length of device 10 extending from lower end 132 to upper end 134 of FIG. 5). This is illustrative and non-limiting. Alternatively, joint 140 and axis 137 may extend parallel to the length of device 10 (e.g., orthogonal to as shown in FIG. 7) or in any desired direction.

If desired, a hinge or other mechanical structure in joint 140 may hold or lock portion 86C-2 in place at one or more different orientations or angles relative to portion 86C-1 (sometimes also referred to herein as cover angles). If desired, joint 140 may include one or more mechanical (e.g., electromechanical) actuators that help to move or rotate portion 86C-2 to different positions. If desired, one or more magnets 82 may be disposed on and/or within portion 86C-2 to help snap or hold cover 86C-2 in place onto device 10 or main body 86R (FIG. 4) when portion 86C-2 is in a closed configuration, an open configuration, or another configuration between the open and closed configurations.

As shown in FIG. 7, phased antenna array 98 may be disposed on portion 86C-2 of removable case 80. The antennas 110 of phased antenna array 98 may be disposed on an exterior surface of portion 86C-2 or may be embedded within portion 86C-2 (e.g., may be formed from conductors laminated between different dielectric layers of portion 86C-2, may be formed from conductive traces on one or more printed circuit boards embedded within portion 86C-2, etc.). In the example of FIG. 7, phased antenna array 98 includes a rectangular four-by-two array or grid of antennas 110. This is illustrative and, in general, phased antenna array 98 may include any desired number of antennas 110 arranged in any desired manner.

Radio-frequency circuitry 96 may also be disposed on and/or within portion 86C-2 of cover 86C (e.g., on a printed circuit board embedded within portion 86C-2). Radio-frequency circuitry 96 may be coupled to antennas 110 over respective radio-frequency transmission line paths 100 in portion 86C-2 of cover 86C. Radio-frequency circuitry 96 may include, for example, phase and magnitude controllers 112 (FIG. 3) for each of the antennas 110 in phased antenna array 98.

RF connector 90C may be disposed on main body 86R (FIG. 6) and may overlap portion 86C-1 of cover 86C. Alternatively, RF connector 96C may be disposed on portion 86C-1 (e.g., in implementations where main body 86R is omitted from removable case 80). RF connector 90C may be coupled to radio-frequency circuitry 96 over a radio-frequency transmission line path 92C in signal path 92 (FIG. 2). Radio-frequency transmission line path 92C may extend from portion 86C-1 to portion 86C-2 across, over, and/or through joint 140. Joint 140 is sometimes also referred to herein as fold 140, axis 140, hinge 140, or bendable region 140. Radio-frequency transmission line path 92C may, for example, be formed from conductive traces on a flexible printed circuit board embedded within cover 86C.

Connector electrodes 90B may be disposed on main body 86R (FIG. 6) and may overlap portion 86C-2 of cover 86C when cover 86C is in the closed configuration. Alternatively, connector electrodes 90B may be disposed on portion 86C-1 or portion 86C-2 of cover 86C (e.g., in implementations where main body 86R is omitted from removable case 80). Connector electrodes 90B may be coupled to radio-frequency circuitry 96 over one or more signal paths 92B (e.g., in signal path 92 of FIG. 3). Signal path(s) 92B may include conductive traces (e.g., on a flexible printed circuit) that extend from one or more connector electrodes 90B through main body 86R (FIG. 6), portion 86C-1, and/or portion 86C-2 of removable case 80 to reach radio-frequency circuitry 96. Wired data connector 90A may be coupled to radio-frequency circuitry 96 over one or more signal paths 92C (e.g., in signal path 92 of FIG. 3). Signal path(s) 92C may include conductive traces (e.g., on a flexible printed circuit) that extend from one or more pins or contacts of wired data connector 90A through main body 86R (FIG. 6), portion 86C-1, and/or portion 86C-2 of removable case 80 to reach radio-frequency circuitry 96.

If desired, radio-frequency transmission line path 92C, radio-frequency circuitry 96, radio-frequency transmission line paths 100, antennas 110, at least some of signal path(s) 92B, at least some of signal path(s) 92A, and/or radio-frequency circuitry 96 may be mounted to the same printed circuit board (e.g., a flexible printed circuit) mounted or laminated within dielectric layers in cover 86C of removable case 80. Alternatively, two or more of these components may be disposed on two or more respective flexible printed circuits in cover 86C. Alternatively, these components may be implemented using conductive material (e.g., conductive traces) disposed or patterned onto dielectric layers of cover 86C (e.g., without disposing printed circuit boards in cover 86C).

During signal transmission, RF connector 90C may receive radio-frequency signals for transmission from the mating/overlapping RF connector 68C on device 10 (FIG. 5). RF connector 90C may pass the radio-frequency signals to radio-frequency circuitry 96 over radio-frequency transmission line path 92C, which distributes the radio-frequency signals to antennas 110 in portion 86C-2 of cover 86C. Phase and magnitude controllers 112 (FIG. 3) in radio-frequency circuitry 96 may apply phase shifts to the radio-frequency signals to cause phased antenna array 98 to form a signal beam oriented in a desired beam pointing direction. Phase antenna array 98 may transmit the radio-frequency signals to a satellite 12 using the formed signal beam. Alternatively, removable case 80 may receive the radio-frequency signals from device 10 via coil(s) 88/70, over connectors electrodes 68B/90B, and/or over wired data connectors 68A/90A.

During signal transmission, phased antenna array 98 may receive radio-frequency signals from a satellite 12. Antennas 110 may pass the received radio-frequency signals to radio-frequency circuitry 96 over radio-frequency transmission line paths 100. Phase and magnitude controllers 112 (FIG. 3) in radio-frequency circuitry 96 may apply phase shifts to the radio-frequency signals in a manner that causes the radio-frequency signals to coherently sum together. Radio-frequency circuitry 96 may pass the coherently summed radio-frequency signals to RF connector 90C over radio-frequency transmission line path 92C. RF connector 90C may pass the coherently summed radio-frequency signals to RF connector 68C on device 10, which passes the radio-frequency signals to a non-NFC transceiver on device 10 for decoding and processing. Alternatively, removable case 80 may transmit the received radio-frequency signals to device 10 over coil(s) 88/70, over connector electrodes 68B/90B, and/or over wired data connectors 68A/90A.

Phase and magnitude controllers 112 may receive, from device 10, control signals CTRL that set the phase and magnitude settings of phase and magnitude controllers 112 (e.g., allowing beam calculation and/or selection to be offloaded to device 10). For example, phase and magnitude controllers 112 in radio-frequency circuitry 96 may receive control signals CTRL from device 10 via wired data connector 68A on device 10 (FIG. 5), wired data connector 90A on removable case 80, and signal path(s) 92A on removable case 80, via connector electrode(s) 68B on device 10 (FIG. 5), connector electrode(s) 90B on removable case 80, and signal path(s) 92B on removable case 80, and/or via coil(s) 70 on device 10, coil(s) 88 on removable case 80 (FIG. 6), and radio-frequency transmission line path 94 (FIG. 2). Alternatively, processing circuitry 108 in removable case 80 (FIG. 3) may generate and/or select the phase and magnitude settings (e.g., based on control signals CTRL received from device 10). Alternatively, a transceiver 109 may be disposed on removable case 80 and may convey radio-frequency signals via radio-frequency circuitry 96 (e.g., while conveying wireless baseband data with device 10 via coil(s) 70/88, via RF connectors 90C/68C, via connector electrodes 90B/68B, and/or via wired connectors 90A/68).

Portion 86C-2 of cover 86C may be movable, relative to device 10 and/or the rest of removable case 80, between at least a closed configuration (orientation) and an open configuration (orientation). The position or orientation of portion 86C-2 relative to portion 86C-1, main body 86R, and/or the rear housing wall of device 10 may be characterized by a corresponding cover angle. If desired, cover 86C may include a cover angle sensor 141 that senses or detects the cover angle of portion 86C-2 at any given time.

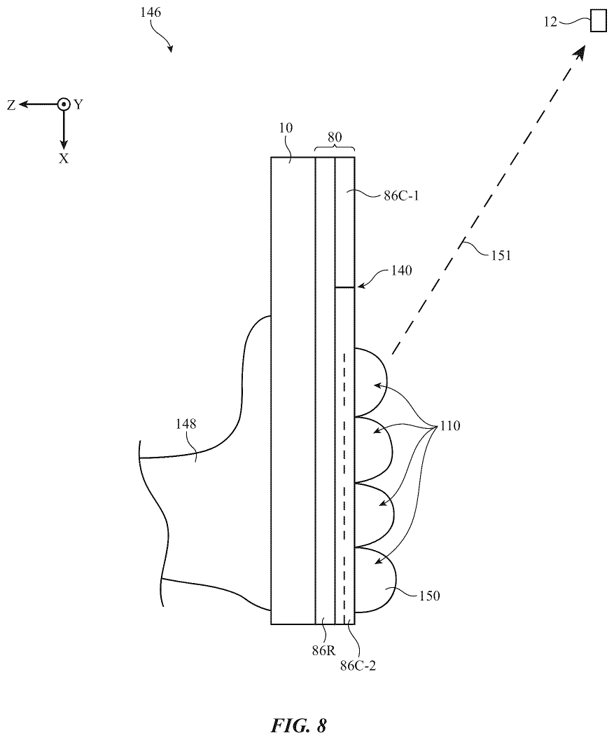

FIG. 8 is a side view (e.g., as viewed in the direction of arrow 144 of FIG. 7) showing one example of how device 10 may communicate with a satellite 12 in space (FIG. 1) while cover 86C (portion 86C-2) is in the closed configuration (sometimes also referred to herein as a closed position or a closed orientation). As shown in FIG. 8, when mounted to removable case 80, device 10 may be layered onto a rigid portion of removable case 80 such as main body 86R. Peripheral sidewalls 86W of removable case 80 are not illustrated in FIG. 8 for the sake of clarity. Alternatively, peripheral sidewalls 86W may be omitted from removable case 80 and the rear housing wall of device 10 may attached to main body 86R (or some of cover 86C in implementations where main body 86R is omitted).

When in the closed configuration, portion 86C-1 may be substantially parallel to (e.g., may be coplanar with) portion 86C-2 of cover 86C (e.g., parallel to the lateral area of main body 86R and the rear housing wall of device 10). Put differently, portion 86C-2 may be oriented at a cover angle of zero degrees with respect to portion 86C-1 about joint 140. When a user holds device 10 in their hand 148, the user's fingers 150 may wrap around the rear of removable case 80 to cover portion 86C-2 of cover 86C. The presence of the user's fingers 150 may block and/or detune some or all of the antennas 110 in portion 86C-2, which can prevent adequate transmission and reception of radio-frequency signals within a signal beam 151 oriented towards satellite 12 in space. In addition, when in the closed configuration, a signal beam 151 oriented towards satellite 12 is at a relatively high angle off of boresight. This can limit the peak gain achievable by the array in communicating with satellite 12 and/or can make it difficult to form a signal beam that sufficiently overlaps the location of satellite 12.

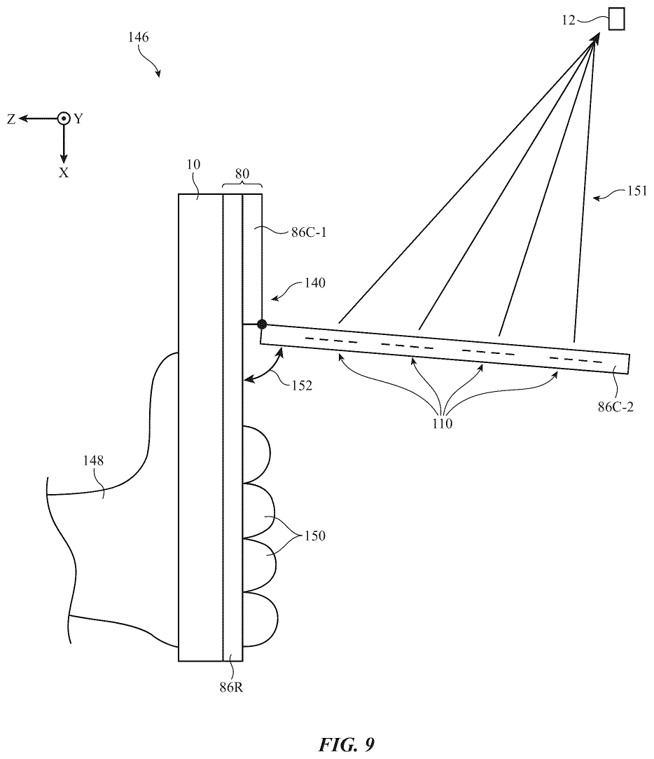

To mitigate these issues, portion 86C-2 may be moved or rotated to an open configuration, orientation, or position for performing satellite-based communications. FIG. 9 is a side view (e.g., as viewed in the direction of arrow 144 of FIG. 7) showing one example of how device 10 may communicate with a satellite 12 (FIG. 1) while cover 86C is in the open configuration.

As shown in FIG. 9, portion 86C-2 of cover 86C may be movable or rotatable about joint 140 across or between a set of two or more cover angles 152 (e.g., measured between the lateral surface of portion 86C-2 and the lateral surface of main body 86R or the rear housing wall of device 10). Cover angle 152 may be equal to zero degrees when cover 86C is in the closed configuration (FIG. 8). When cover 86C is in the open configuration, cover angle 152 may be equal to 90 degrees, between 70-90 degrees, between 80-100 degrees, between 45-135 degrees, or any other desired angle between around 60 degrees and around 180 degrees. The set of two or more cover angles may include only the cover angles when cover 86C is in the open and closed configurations or may include any desired number of additional cover angles between the cover angles in the open and closed configurations.

If desired, a hinge or other mechanical structures in joint 140 may rigidly hold or fix portion 86C-2 in place at each cover angle 152 in the set of cover angles (e.g., such that portion 86C-2 remains open at the corresponding cover angle 152 without falling back downwards under an external force less than or equal to a threshold force, where the threshold force is equal to at least the force of gravity). If desired, the user may apply an external force exceeding the threshold force to move cover 86C between each cover angle 152 in the set of cover angles between the open configuration and the closed configuration. If desired, joint 140 may include a mechanical actuator that autonomously moves the cover to different cover angles (e.g., in response to a software instruction issued by an application running on device 10) without requiring the user to manually move the cover.

When in the open configuration (or in another non-closed orientation), the user's fingers 150 may wrap around device 10 and main body 86R of cover 86C without blocking portion 86C-2 of cover 86C (e.g., fingers 150 may be angularly interposed between device 10 and portion 86C-2 of cover 86C, whereas portion 86C-2 of cover 86 is interposed between fingers 150 and satellite 12). This prevents fingers 150 from blocking or detuning the antennas 110 in portion 86C-2 of cover 86C. In addition, the open configuration of portion 86C-2 may allow phased antenna array 98 to form a signal beam 151 that is orientated towards a satellite 12 overhead at an angle closer to boresight than when portion 86C-2 is in the closed configuration. This may serve to maximize the gain with which the array communicates with satellite 12 and helps to maximize the likelihood that the signal beam overlaps the spatial location of satellite 12.

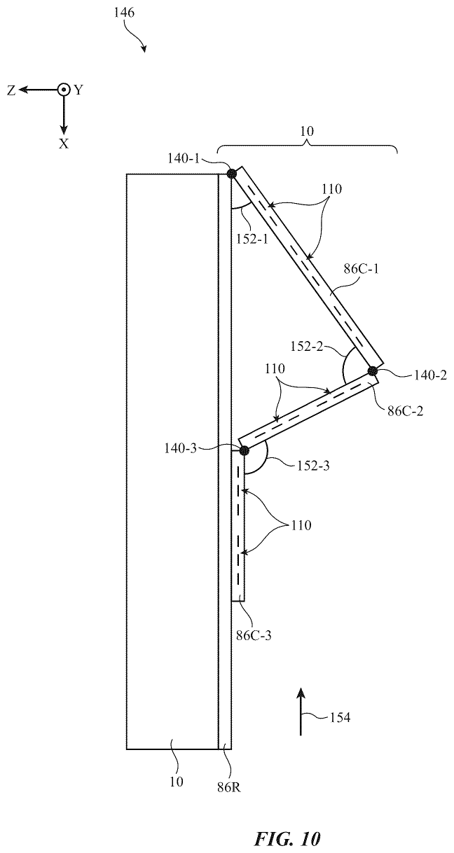

The example of FIGS. 7-9 in which cover 86C includes two portions coupled together at a single joint 140 is illustrative and non-limiting. In general, cover 86C may include any desired number of rigid portions coupled together at any desired number of two or more joints 140. FIG. 10 illustrates another example in which cover 86C includes three rigid portions that move between different cover angles about three joints 140.

As shown in FIG. 10, cover 86C may include portions 86C-1, 86C-2, and 86C-3. Portion 86C-1 may be coupled to main body 86R (or the rear wall of device 10 when main body 86R is omitted) at joint 140-1. Portion 86C-2 may be coupled to portion 86C-1 at joint 140-2 and may be coupled to portion 86C-3 at joint 140-3. Portion 86C-1 may be rotatable about joint 140-1 through a set of two or more cover angles 152-1 relative to main body 86R and/or the rear wall of device 10. Portion 86C-2 may be independently rotatable about joint 140-2 through a set of two or more cover angles 152-2 relative to portion 86C-1. Portion 86C-3 may be independently rotatable about joint 140-3 through a set of two or more cover angles 152-3 relative to portion 86C-2.

If desired, magnets in portion 86C-3 may help to lock portion 86C-3 in place parallel to main body 86R and/or the rear housing wall of device 10 in the open and closed configurations. Portions 86C-1, 86C-2, and 86C-3 may all be substantially parallel to the rear housing wall of device 10 when cover 86C is in the closed configuration (e.g., cover angle 152-1 may be equal to zero degrees whereas cover angles 152-2 and 152-3 are equal to 180 degrees). An external force 154 may be applied in an upward direction to cover 86C to move cover 86C into the open configuration (shown in FIG. 10). Phased antenna array 98 may include one or more antennas 110 disposed on portion 86C-1, on portion 86C-2, and/or on portion 86C-3. In the open configuration, cover angles 152-1, 152-2, and 152-3 are all non-zero and less than 180 degrees. This example is illustrative and, in general, cover 86C may include any desired number of portions that fold or bend about any desired number of axes in the open configuration.

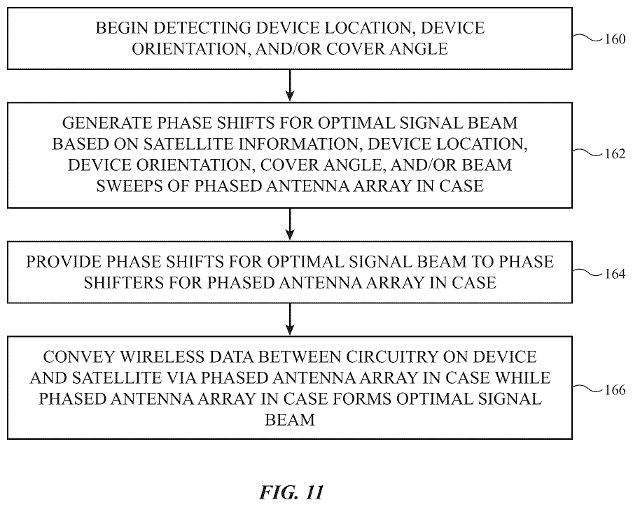

FIG. 11 is a flow chart of operations involved in using a device 10 mounted to a removable case 80 to perform wireless communications with a satellite 12. At operation 160, device 10 may begin detecting its own location (e.g., using a satellite navigation receiver that receives signals from a global navigation satellite system (GNSS) that is different than constellation 32). If desired, device 10 may begin detecting its own orientation (e.g., using an orientation sensor). If desired, device 10 may begin detecting one or more cover angles 152 of the cover 86C of removable case 80 (e.g., using cover angle sensor 141 of FIG. 7, which may transmit control signals that identify cover angles 152 to device 10 over coils 70/88, RF connectors 90C/68C, connector electrodes 90B/68B, and/or wired data connectors 90A/68A). Device 10 may continue detecting location, orientation, and/or cover angle while processing the remaining operations of FIG. 11.

At operation 162, one or more processors in device 10 (e.g., processing circuitry 44 of FIG. 2) and/or removable case 80 (e.g., processing circuitry 108 of FIG. 3) may generate phase and magnitude settings for the phased antenna array 98 on removable case 80. The generated phase and magnitude settings (sometimes referred to herein simply as phase shifts) may be phase and magnitude settings that cause phased antenna array 98 to form an optimal signal beam for communicating with a corresponding satellite 12 given the current location of device 10, the current orientation of device 10, the location of the corresponding satellite 12, and/or the current cover angle.

The processor(s) may generate the phase and magnitude settings based on the detected device location, the spatial location of satellite 12 (e.g., as identified in the ephemeris data of satellite information 48 of FIG. 2), the detected cover angle, and/or one or more beam sweeps of the signal beam formed by phased antenna array 98. For example, if the position and orientation of device 10 relative to satellite 12 is known (e.g., from satellite navigation receiver data, orientation sensor data, and satellite ephemeris data) and the position of the phased antenna array 98 in cover 86C is known (e.g., from cover angle sensor data), the processing circuitry may determine the spatial orientation of phased antenna array 98 relative to satellite 12 and may generate phase and magnitude settings that form a signal beam pointing from the determined spatial orientation of the phased antenna array towards the known location of satellite 12. If desired, the processor(s) may sweep phased antenna array 98 through some or all of its formable signal beams while listening for signals from satellite 12 and may identify, as the optimal signal beam, the signal beam that resulted in the signals being received from satellite 12 with a peak wireless performance metric (e.g., received signal strength, signal-to-noise ratio, etc.). This may help to ensure that an optimal signal beam is identified regardless of cover angle, device position, and device orientation.

At operation 164, the processor(s) may provide the phase and magnitude settings to phase and magnitude controllers 112 for phased antenna array 98. As one example, device 10 may transmit the phase and magnitude settings to phase and magnitude controllers 112 using control signals CTRL transmitted over control path 107 of FIG. 3. As another example, processing circuitry 108 on removable case 80 (FIG. 3) may control phase and magnitude controllers 112 to implement the phase and magnitude settings (e.g., based on a control signal CTRL received over path 107). Phase and magnitude controllers 112 may then begin applying the phase and magnitude settings to transmitted and/or received signals, effectively forming the optimal signal beam.

At operation 166, device 10 may convey wireless data with satellite 12 via the phased antenna array 98 in removable case 80 while the phased antenna array forms the optimal signal beam. The wireless data may be carried by a radio-frequency signal transmitted between RF connectors 90C and 68C, for example. When cover 86C is in the open configuration, the optimal signal beam may exhibit sufficient levels of wireless performance in communicating with satellite 12 without the array being blocked by external objects such as the user's fingers. Beam forming may be updated as the device position, device orientation, satellite position, and/or cover angle changes over time.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

One or more elements described herein (e.g., device 10, removable case 80, etc.) may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing is merely illustrative and various modifications can be made to the described embodiments. The foregoing embodiments may be implemented individually or in any combination.

What is claimed is:

1. A removable case configured to receive an electronic device that supports wireless communications with external equipment, comprising:
a cover that includes a first portion and a second portion coupled to the first portion at a joint, wherein the first portion has a fixed orientation relative to a rear housing wall of the electronic device while the electronic device is received by the removable case, the second portion being configured to rotate with respect to the first portion about the joint; and
a phased antenna array in the second portion of the cover and configured to convey wireless data between the electronic device and the external equipment.

2. The removable case of claim 1, further comprising:
phase and magnitude controllers in the second portion of the cover and configured to form a signal beam for the phased antenna array.

3. The removable case of claim 2, further comprising:
a connector configured to receive a control signal from the electronic device, wherein the phase and magnitude controllers are configured to form the signal beam based on the control signal received by the connector.

4. The removable case of claim 3, wherein the connector comprises a first connector electrode configured to overlap a second connector electrode on the electronic device.

5. The removable case of claim 4, further comprising:
a main body portion that is coupled to the first portion of the cover, that overlaps the cover, and that extends parallel to the first portion of the cover and the rear housing wall of the electronic device, the first connector electrode being disposed at a location on the main body portion that overlaps the second portion of the cover.

6. The removable case of claim 4, wherein the first connector electrode is disposed on the first portion of the cover.

7. The removable case of claim 3, further comprising:
peripheral sidewalls configured to extend around a periphery of the electronic device, wherein the connector comprises a first wired data connector in the peripheral sidewalls and configured to mate with a second wired data connector in peripheral conductive housing structures of the electronic device.

8. The removable case of claim 2, further comprising:
a coil; and
near-filed communications (NFC) circuitry configured to receive a control signal from the electronic device via the coil, wherein the phase and magnitude controllers are configured to form the signal beam based on the control signal.

9. The removable case of claim 2, further comprising:
a main body portion that is coupled to the first portion of the cover, that overlaps the cover, and that extends parallel to the first portion of the cover and the rear housing wall of the electronic device; and
a first battery in the main body portion, wherein the coil is configured to transmit wireless power signals to an additional coil on the electronic device that charge a second battery on the electronic device.

10. The removable case of claim 2, further comprising:
a first radio-frequency connector configured to couple to a second radio-frequency connector on the electronic device and configured to receive the wireless data in a radio-frequency signal transmitted by the electronic device over the second radio-frequency connector; and
a radio-frequency transmission line path that extends through the first and second portions of the cover and that couples the first radio-frequency connector to the phase and magnitude controllers.

11. The removable case of claim 10, wherein the radio-frequency connector is disposed on the first portion of the cover.

12. The removable case of claim 10, further comprising:
a main body portion that is coupled to the first portion of the cover, that overlaps the cover, and that extends parallel to the first portion of the cover and the rear housing wall of the electronic device, wherein the first radio-frequency connector is disposed on the main body portion and overlaps the first portion of the cover.

13. The removable case of claim 1, further comprising:
a first coil;
near-field communications (NFC) circuitry configured to receive the wireless data from a second coil on the electronic device; and
a satellite communications modem communicatively coupled between the NFC circuitry and the phased antenna array, the satellite communications modem being configured to convey, using the phased antenna array, radio-frequency signals that carry the wireless data.

14. The removable case of claim 1, wherein the second portion of the cover is configured to rotate between a closed orientation and an open orientation, the second portion of the cover extends parallel to the first portion of the cover while in the closed orientation, and the second portion of the cover is oriented at an angle between 45 degrees and 135 degrees relative to the rear housing wall of the electronic device while in the open orientation.

15. The removable electronic device of claim 14, wherein the cover comprises a hinge at the joint, the hinge being configured to hold the second portion of the cover at the angle while in the open orientation.

16. A removable case for an electronic device, comprising:
a body having a first portion configured to receive the electronic device, a second portion coupled to the first portion and extending parallel to the first portion, and a third portion coupled to the second portion, wherein the third portion is configured to rotate relative to the second portion about an axis between a closed position and an open position;
a radio-frequency connector on the first portion, overlapping the second portion of the body, and configured to receive a radio-frequency signal from the electronic device;
an array of antennas on the third portion of the body; and
a transmission line path that extends from the second portion to the third portion of the body and that couples the radio-frequency connector to the array of antennas, the array of antennas being configured to transmit the radio-frequency signal.

17. The removable case of claim 16, further comprising:
a flexible printed circuit that extends from the second portion to the third portion of the body, the transmission path comprising conductive traces on the flexible printed circuit.

18. The removable case of claim 16, wherein the third portion extends parallel to the first portion of the body while in the closed position, the third portion being orthogonal to the first portion of the body while in the open position.

19. A removable case for an electronic device, comprising:
a housing that includes a main body portion configured to receive the electronic device and that includes a cover coupled to the main body portion, the cover being configured to rotate relative to the main body portion between a closed position and an open position;
beamforming circuitry on the cover and configured to receive a control signal from the electronic device; and
a phased antenna array on the cover and coupled to the beamforming circuitry, wherein the beamforming circuitry is configured to control the phased antenna array to form a signal beam based on the control signal, the phased antenna array being configured to transmit, over the signal beam, wireless data received from the electronic device while the signal beam is oriented towards a satellite in orbit above Earth and while the cover is in the open position.

20. The removable case of claim 19, further comprising:
a connector electrode on the main body portion, wherein the connector electrode overlaps the cover while the cover is in the closed position; and
a near-field communications (NFC) coil on the main body portion, wherein the NFC coil overlaps the cover while the cover is in the closed position, the control signal being received from the electronic device via the connector electrode or the NFC coil.
